(19) United States
(12) Patent Application Publication
(10) Pub. No.: US 2026/0003898 A1
(43) Pub. Date: Jan. 1, 2026

(54) METHOD, ELECTRONIC DEVICE, AND STORAGE MEDIUM FOR GENERATING RECOMMENDATION MESSAGE

(71) Applicant: TENCENT TECHNOLOGY (SHENZHEN) COMPANY LIMITED, Shenzhen (CN)

(72) Inventor: Zhen TAN, Shenzhen (CN)

(21) Appl. No.: 19/319,663

(22) Filed: Sep. 4, 2025

Related U.S. Application Data
(63) Continuation of application No. PCT/CN2023/133225, filed on Nov. 22, 2023.

(30) Foreign Application Priority Data
Jul. 5, 2023 (CN) 202310816787.8

(51) Int. Cl. G06F 16/3329; G06F 16/334; G06F 40/30

(52) U.S. Cl. CPC G06F 16/3329; G06F 16/3347; G06F 40/30

(57) ABSTRACT

A method for generating a recommendation message includes: obtaining a recommendation request for content, the recommendation request containing a content description for recommendation; predicting a seed attribute of the content based on the content description; performing information retrieval in an information database based on the content description and the seed attribute to obtain supplementary information corresponding to the content description and the seed attribute; populating a prompt template with the content description and the supplementary information to obtain a query message; and generating, based on the query message, a recommendation message of the content for recommendation using a first large-scale pre-trained language model.

### RELATED APPLICATIONS

This application is a continuation application of PCT Patent Application No. PCT/CN2023/133225, filed on Nov. 22, 2023, which claims priority to Chinese Patent Application No. 202310816787.8, filed on Jul. 5, 2023, all of which is incorporated herein by reference in their entirety.

### FIELD OF THE TECHNOLOGY

The present disclosure relates to the field of artificial intelligence, and in particular, to a recommendation message generation technology.

### BACKGROUND OF THE DISCLOSURE

In the era of big data, content often needs to be delivered or recommended on the Internet. When the content is recommended, a recommendation message is required. A good recommendation message helps improve content conversion rates, that is, a rate at which the content is clicked, viewed, or responded to. Currently, methods for automatically generating a recommendation message for to-be-recommended content mainly include a neural network model and use of recommendation message templates. For example, the to-be-recommended content may be inputted into the neural network model, and the neural network model automatically generates the recommendation message. However, the accuracy of the generated recommendation message is not high, which often fails to accurately reflect actual characteristics of the to-be-recommended content, resulting in low content conversion rates after recommendation. When recommendation message templates are used, a fixed template is often applied regardless of the type of content being recommended, resulting in lower accuracy and low conversion rates of the recommendation messages.

### SUMMARY

One embodiment of the present disclosure provides a method for generating a recommendation message. The method is performed by an electronic device and includes: obtaining a recommendation request for content, the recommendation request containing a content description for recommendation; predicting a seed attribute of the content based on the content description; performing information retrieval in an information database based on the content description and the seed attribute to obtain supplementary information corresponding to the content description and the seed attribute; populating a prompt template with the content description and the supplementary information to obtain a query message; and generating, based on the query message, a recommendation message of the content for recommendation using a first large-scale pre-trained language model.

Another embodiment of the present disclosure provides an electronic device. The electronic device includes one or more processors and a memory containing a computer program that, when being executed, causes the one or more processors to perform: obtaining a recommendation request for content, the recommendation request containing a content description for recommendation; predicting a seed attribute of the content based on the content description; performing information retrieval in an information database based on the content description and the seed attribute to obtain supplementary information corresponding to the content description and the seed attribute; populating a prompt template with the content description and the supplementary information to obtain a query message; and generating, based on the query message, a recommendation message of the content for recommendation using a first large-scale pre-trained language model.

Another embodiment of the present disclosure provides a non-transitory computer-readable storage medium containing a computer program that, when being executed, causes the at least one processor to perform: obtaining a recommendation request for content, the recommendation request containing a content description for recommendation; predicting a seed attribute of the content based on the content description; performing information retrieval in an information database based on the content description and the seed attribute to obtain supplementary information corresponding to the content description and the seed attribute; populating a prompt template with the content description and the supplementary information to obtain a query message; and generating, based on the query message, a recommendation message of the content for recommendation using a first large-scale pre-trained language model.

### BRIEF DESCRIPTION OF THE DRAWINGS

The accompanying drawings, which are intended to provide a further understanding of technical solutions of the present disclosure and constitute a part of the specification, illustrate the technical solutions of the present disclosure in combination with embodiments of the present disclosure and do not constitute a limitation to the technical solutions of the present disclosure.

FIG. 1A is a schematic diagram of a network architecture applied to a recommendation message generation method according to an embodiment of the present disclosure.

FIG. 1B is a schematic diagram of a single-device architecture applied to a recommendation message generation method according to an embodiment of the present disclosure.

FIG. 2A to FIG. 2E are schematic diagrams of an application scene of a recommendation message generation method according to an embodiment of the present disclosure.

FIG. 3 is a schematic flowchart of a recommendation message generation method according to an embodiment of the present disclosure.

FIG. 4 is a diagram of a specific example corresponding to the flowchart in FIG. 3.

FIG. 5 is a specific flowchart of an exemplary operation shown in FIG. 3 for predicting a seed attribute of the content based on the content description.

FIG. 6 is a diagram of a specific example corresponding to the flowchart in FIG. 5.

FIG. 7 is a specific flowchart of an exemplary operation shown in FIG. 3 for performing information retrieval in information database based on the content description and the seed attribute.

FIG. 8 is a specific flowchart of an exemplary operation shown in FIG. 7 for acquiring screened supplementary information units matching the content description and integrating the screened supplementary information units into the supplementary information.

FIG. 9 is a diagram of a specific example corresponding to the flowchart in FIG. 8.

FIG. 10 is a specific flowchart of generating an information database according to an embodiment of the present disclosure.

FIG. 11 is a specific flowchart of an exemplary operation shown in FIG. 10 for acquiring seed words based on the recommendation message browsing record.

FIG. 12 is a diagram of a specific example corresponding to the flowchart in FIG. 11.

FIG. 13 is a specific flowchart of an exemplary operation shown in FIG. 10 for generating the supplementary information units based on the candidate segments to form the information database.

FIG. 14 is a diagram of a specific example corresponding to the flowchart in FIG. 13.

FIG. 15 is a specific flowchart of an exemplary operation shown in FIG. 3 for populating a prompt template with the content description and the supplementary information to obtain a query message.

FIG. 16 is a diagram of a specific example corresponding to the flowchart in FIG. 15.

FIG. 17 is a specific flowchart of an exemplary operation shown in FIG. 15 for inputting the first vector into the first large-scale pre-trained language model and a first model that are connected in parallel, to obtain a second vector.

FIG. 18 is a diagram of a specific example corresponding to the flowchart in FIG. 17.

FIG. 19 is a specific flowchart of generating a first output according to an embodiment of the present disclosure.

FIG. 20 is a diagram of a specific example corresponding to the flowchart in FIG. 19.

FIG. 21 is a more specific schematic flowchart of generating a first output.

FIG. 22 is a specific flowchart of an exemplary operation shown in FIG. 3 for generating, based on the query message, a recommendation message of the content using a first large-scale pre-trained language model.

FIG. 23 is a diagram of a specific example corresponding to the flowchart in FIG. 22.

FIG. 24 is a specific flowchart of an exemplary operation shown in FIG. 22 for determining an object group to which a target object belongs.

FIG. 25 is a more specific schematic flowchart of an exemplary operation shown in FIG. 3 for generating, based on the query message, a recommendation message of the content using a first large-scale pre-trained language model.

FIG. 26 is a diagram of a specific example corresponding to the flowchart in FIG. 25.

FIG. 27 is a diagram of a specific example of connecting a second large-scale pre-trained language model and a second model in parallel according to the present disclosure.

FIG. 28 is an exemplary diagram of a summary presentation of a specific embodiment according to the present disclosure.

FIG. 29 is a block diagram of modules of a recommendation message generation apparatus according to an embodiment of the present disclosure.

FIG. 30 is a structural diagram of a terminal that implements the recommendation message generation method shown in FIG. 3 according to an embodiment of the present disclosure.

FIG. 31 is a structural diagram of a server that implements the recommendation message generation method shown in FIG. 3 according to an embodiment of the present disclosure.

### DESCRIPTION OF EMBODIMENTS

To make the objectives, technical solutions, and advantages of the present disclosure clearer, the present disclosure is further described in detail below in conjunction with the accompanying drawings and embodiments. The specific embodiments described herein are for the sole purpose of explaining the present disclosure and are not intended to limit the present disclosure.

In specific embodiments of the present disclosure, when related processing needs to be performed according to data related to a property of a target object, such as attribute information or an attribute information set of the target object, permission or consent of the target object is first obtained, and acquisition, usage, processing, and the like of the data comply with related laws, regulations, and standards. In addition, when the attribute information of the target object needs to be obtained in the embodiments of the present disclosure, individual permission or individual consent of the target object is obtained through a pop-up window or jumping to a confirmation page. After the individual permission or the individual consent of the target object is explicitly obtained, necessary target object-related data for enabling the embodiments of the present disclosure to operate normally is obtained.

A method provided in the embodiments of the present disclosure mainly relates to the technical field of artificial intelligence, mainly involving automatically generating a recommendation message using the artificial intelligence technology.

The method provided in the embodiments of the present disclosure mainly relates to the natural language processing technology in the artificial intelligence technology, machine learning, and large-scale pre-trained language models. A recommendation request of to-be-recommended content is mainly processed through the natural language processing technology to generate a recommendation message, and a first large-scale pre-trained language model is used in the process of generating the recommendation message. The first large-scale pre-trained language model is mainly a large-scale pre-trained language model and may be obtained through machine learning training. The large-scale pre-trained language model is a language model pre-trained on a large-scale text corpus. These models are usually trained on a large amount of unmarked text data using a self-supervised learning method to learn a language structure and semantic information in the text. These models have powerful representation capabilities and may be applied to various natural language processing tasks, such as text generation, text classification, sequence annotation, and machine translation. In addition, the large-scale pre-trained language model may further adapt to requirements of a specific task through technologies such as fine tuning, thereby achieving better performance.

In the era of big data, content often needs to be delivered or recommended on the Internet. When the content is recommended, a recommendation message is required. A good recommendation message is beneficial to improving a content conversion rate, where the content conversion rate is a rate at which content is clicked, viewed, responded to, and the like. The good recommendation message is a recommendation message with relatively high quality. However, factors that determine the quality of the recommendation message may include, but are not limited to: summarizing core content that needs to be recommended, meeting the public demand, a specific type of recommendation message meeting a writing specification, and having language expression skills. Writing a recommendation message by relying on high-quality manpower is obviously a method with high costs and low efficiency. Therefore, a method for automatically generating a recommendation message is a mainstream in the related field. Currently, methods for automatically generating a recommendation message according to to-be-recommended content mainly include a neural network model, applying a recommendation message template, and the like. In the former method, the to-be-recommended content may be inputted into the neural network model, and the neural network model automatically generates the recommendation message. The recommendation message generated by this method has low accuracy, cannot accurately reflect actual characteristics of the to-be-recommended content, and has a low content conversion rate after recommendation. In the latter method, a fixed template is applied regardless of the to-be-recommended content, resulting in lower accuracy and conversion rate of the recommendation message. Therefore, there is an urgent need in the industry for a recommendation message generation method, which has high generation efficiency and a high-quality generated recommendation message.

### Descriptions of System Architecture and Scenes Applied by Embodiments of the Present Disclosure

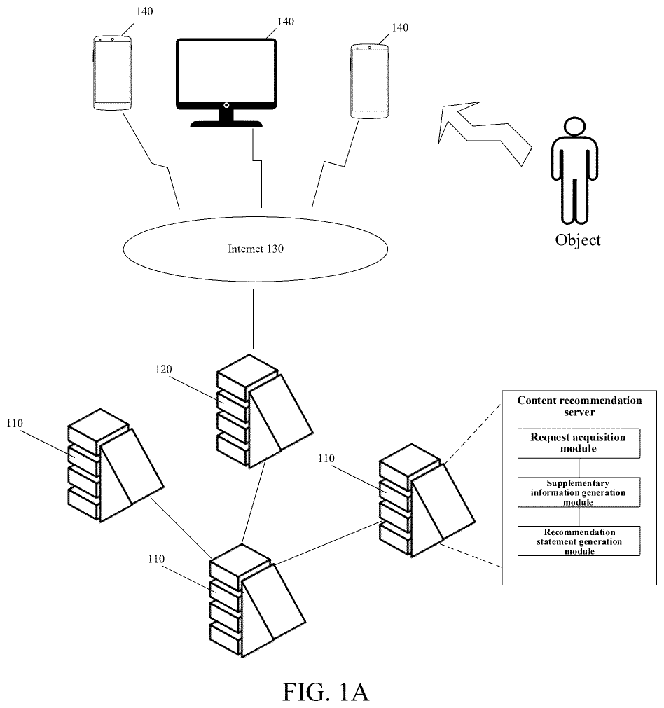

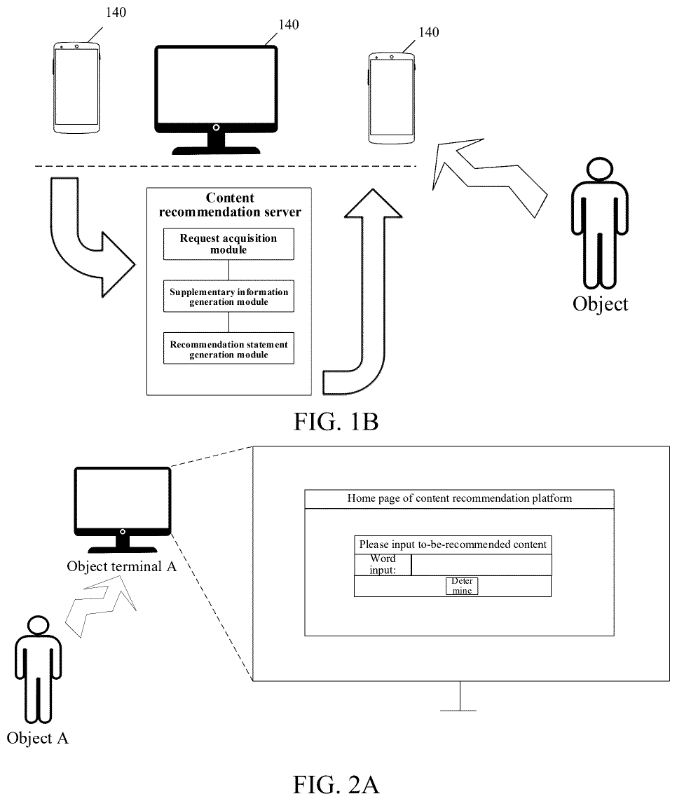

FIG. 1A is a diagram of a network architecture to which a recommendation message generation method for content recommendation is applied according to an embodiment of the present disclosure. The diagram of the network architecture includes a content recommendation server 110, a gateway 120, the Internet 130, an object terminal 140, and the like.

The content recommendation server 110 refers to a computer system that can provide a content delivery service to the object terminal 140. Compared with the object terminal 140, the content recommendation server 110 has higher requirements in aspects such as stability, security, and performance. The content recommendation server 110 may be a high-performance computer in a network platform, a cluster of a plurality of high-performance computers, a part (for example, a virtual machine) of a high-performance computer, a combination of parts (for example, virtual machines) of a plurality of high-performance computers, or the like. The content recommendation server 110 may further communicate with the Internet 130 in a wired or wireless manner to exchange data. The content recommendation server 110 includes a request acquisition module, a supplementary information generation module, and a recommendation message generation module. The request acquisition module is configured to acquire a recommendation request of to-be-recommended content, the recommendation request containing a to-be-recommended content description; and predict a seed attribute of the to-be-recommended content based on the to-be-recommended content description. The supplementary information generation module is configured to perform information retrieval in an information database based on the to-be-recommended content description and the seed attribute to obtain supplementary information corresponding to the to-be-recommended content description and the seed attribute. The recommendation message generation module is configured to populate a prompt template with the to-be-recommended content description and the supplementary information to obtain a query message, and then generate, based on the query message, a recommendation message of the to-be-recommended content using a first large-scale pre-trained language model to transmit the recommendation message to the object terminal 140 for displaying. The request acquisition module, the supplementary information generation module, and the recommendation message generation module may be integrated in the same content recommendation server 110, or may be separately deployed in different servers, and are not limited to the foregoing specific embodiments.

The gateway 120 is alternatively referred to as an inter-network connector or a protocol converter. The gateway implements network interconnection on a transport layer and is a computer system or device providing a conversion function. The gateway is a translator between two systems that use different communication protocols, data formats or languages, or even completely different architectures. Meanwhile, the gateway may further provide filtering and security functions. A message transmitted by the terminal 140 to the content recommendation server 110 needs to be transmitted to the corresponding content recommendation server 110 through the gateway 120. A message transmitted by the content recommendation server 110 to the terminal 140 also needs to be transmitted to the corresponding terminal 140 through the gateway 120.

The object terminal 140 is a device configured to deliver content so that an object views the delivered content. It includes a plurality of forms such as a desktop computer, a laptop computer, a personal digital assistant (PDA), a mobile phone, an in-vehicle terminal, a home theater terminal, and a dedicated terminal. In addition, the object terminal 140 may be a single device or a collection of a plurality of devices. For example, the plurality of devices are connected through a local area network, and share a display device to work together to form a terminal. The terminal may further communicate with the Internet 130 in a wired or wireless manner to exchange data.

The recommendation message generation method for content recommendation in this embodiment of the present disclosure may not only be applied online but also on a single device.

FIG. 1B is a diagram of a single-device network architecture to which a

recommendation message generation method for content recommendation is applied according to an embodiment of the present disclosure. The architecture includes an object terminal 140 provided with a request acquisition module, a supplementary information generation module, and a recommendation message generation module. The request acquisition module is configured to acquire a recommendation request of to-be-recommended content, the recommendation request containing a to-be-recommended content description; and predict a seed attribute of the to-be-recommended content based on the to-be-recommended content description. The supplementary information generation module is configured to perform information retrieval in an information database based on the to-be-recommended content description and the seed attribute to obtain supplementary information corresponding to the to-be-recommended content description and the seed attribute. The recommendation message generation module is configured to populate a prompt template with the to-be-recommended content description and the supplementary information to obtain a query message, then generate, based on the query message, a recommendation message of the to-be-recommended content using a first large-scale pre-trained language model, and display the recommendation message on a display screen of the object terminal 140.

This embodiment of the present disclosure may be applied to a plurality of scenes. A recommendation request may be obtained according to a to-be-recommended content description inputted by words, and then a recommendation message is generated based on the recommendation request. Alternatively, the inputted voice may be converted into a to-be-recommended content description in a text form to obtain a recommendation request, and then a recommendation message is generated based on the recommendation request. There may further be other types of application scenes, which are not listed one by one herein.

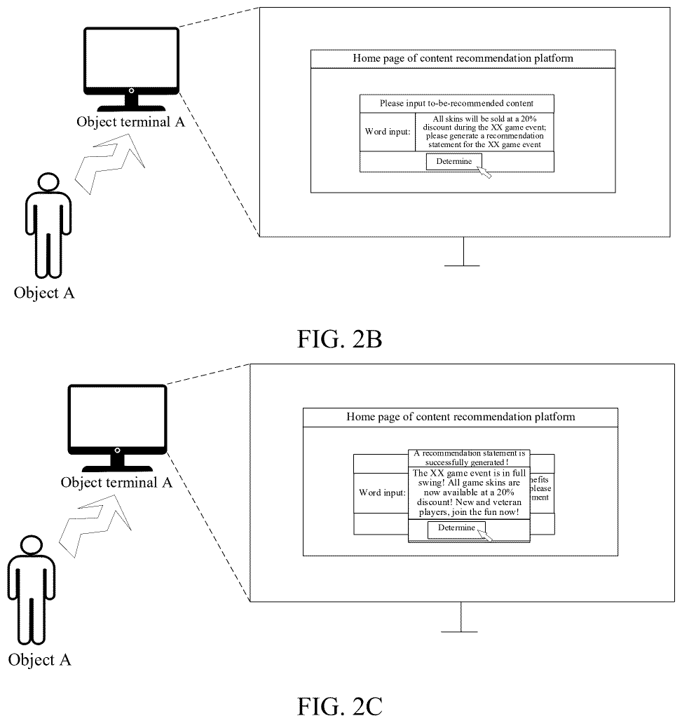

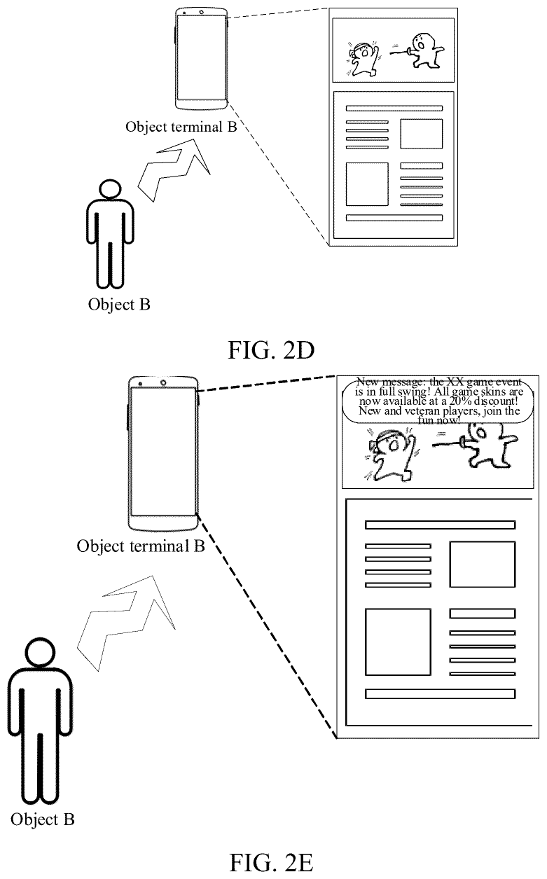

Some application scenes for generating recommendation messages are described below with reference to FIG. 2A to FIG. 2C.

Referring to FIG. 2A, when some recommendation messages need to be generated, an object A may input to-be-recommended content descriptions in a form of words on a home page of a content recommendation platform. The to-be-recommended content description may include to-be-recommended news information, or may further include a restriction requirement on the recommendation message, and may further specify a specific type of the recommendation message.

Referring to FIG. 2B, a to-be-recommended content description inputted by the object A on an object terminal A is specifically “All skins will be sold at a 20% discount during the XX game event; please generate a recommendation message for the XX game event”. After the input is completed, an “OK” button is clicked, and then a recommendation request of the to-be-recommended content is obtained so that a system background generates the recommendation message according to the to-be-recommended content description in the recommendation request. A process in which the system background generates the recommendation message according to the to-be-recommended content description in the recommendation request may include: acquiring a recommendation request of to-be-recommended content, the recommendation request containing a to-be-recommended content description; predicting a seed attribute of the to-be-recommended content based on the to-be-recommended content description; performing information retrieval in an information database based on the to-be-recommended content description and the seed attribute to obtain supplementary information corresponding to the to-be-recommended content description and the seed attribute; populating a prompt template with the to-be-recommended content description and the supplementary information to obtain a query message; and generating, based on the query message, a recommendation message of the to-be-recommended content using a first large-scale pre-trained language model.

Referring to FIG. 2C, after the system background generates the recommendation message according to the to-be-recommended content description in the recommendation request, the recommendation message “The XX game event is in full swing! All game skins are now available at a 20% discount! New and veteran players, join the fun now!” is displayed immediately.

Referring to FIG. 2D, before displaying the recommendation message, an object B is watching a web live broadcast and browsing news using an object terminal B.

Referring to FIG. 2E, after the recommendation message is generated, it is pushed to the object terminal B for displaying. The recommendation message is displayed on an interface of the object terminal B in the form of a notification bar. Certainly, the recommendation message can alternatively be displayed on the interface of the object terminal B in the form of a short message, a pop-up window, etc.

In some specific embodiments, after the recommendation message is displayed, the recommendation message may further be copied for use in other places. In other specific embodiments, after the recommendation message is displayed, the recommendation message may further be pushed outward so that the recommendation message can be clicked, viewed, or responded to.

The application scenes of the recommendation message generation method for content recommendation in this embodiment of the present disclosure are various and are not limited to the foregoing examples.

### General Descriptions of the Embodiments of the Present Disclosure

Embodiments of the present disclosure provide a recommendation message generation method for content recommendation, a related apparatus, and a medium, which can improve the accuracy of generating a recommendation message and a recommendation conversion rate.

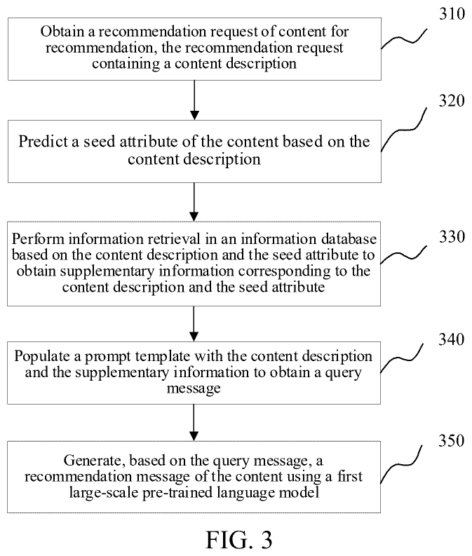

As shown in FIG. 3, in some embodiments of the present disclosure, a recommendation message generation method for content recommendation is provided. The method may be performed by an electronic device. The electronic device may be at least one of an object terminal or a server. The method may include, but is not limited to, operation 310 to operation 350 described below.

Operation 310: Obtain a recommendation request of to-be-recommended content, the recommendation request containing a to-be-recommended content description.

Operation 320: Predict a seed attribute of the to-be-recommended content based on the to-be-recommended content description.

Operation 330: Perform information retrieval in an information database based on the to-be-recommended content description and the seed attribute to obtain supplementary information corresponding to the to-be-recommended content description and the seed attribute.

Operation 340: Populate a prompt template with the to-be-recommended content description and the supplementary information to obtain a query message.

Operation 350: Generate, based on the query message, a recommendation message of the to-be-recommended content using a first large-scale pre-trained language model. Operation 310 to operation 350 are described in detail below.

The recommendation message generation method for content recommendation of operation 310 to operation 350 may be performed by the object terminal 140 alone, or may be performed by the server 110 alone, or may be jointly performed by the object terminal 140 and the server 110.

In operation 310, the recommendation request of the to-be-recommended content is acquired, and the recommendation request contains the to-be-recommended content description. The to-be-recommended content refers to content that needs to be delivered or recommended on the Internet, and the to-be-recommended content description is a description of the to-be-recommended content. The to-be-recommended content description may include to-be-recommended news information, or may further include a restriction requirement on the recommendation message, and may further specify a specific type of the recommendation message. The recommendation request is a request configured for initiating the generation of the recommendation message, and the recommendation request contains the to-be-recommended content description.

In some specific embodiments, when the to-be-recommended content description includes the to-be-recommended news information, the to-be-recommended content description may be “In the XX game event, XXX benefits will be distributed to all players”, “The XXX brand car exhibition will be held in XXX soon”, or the like. When the to-be-recommended content description includes the to-be-recommended news information and the restriction requirement on the recommendation message, the to-be-recommended content description may be “In the XX game event, XXX benefits will be distributed to all players, please generate a recommendation copy within 15 characters”, “The XXX brand car exhibition will be held in XXX soon, please generate a recommendation copy of no less than 30 characters”, or the like. When the to-be-recommended content description includes the to-be-recommended news information, the restriction requirement on the recommendation message, and the specific type of the recommendation message, the to-be-recommended content description may be “In the XX game event, XXX benefits will be distributed to all players, please generate a recommendation copy within 15 characters, where the copy is an announcement for all players”, “The XXX brand car exhibition will be held in XXX soon, please generate a recommendation copy of no less than 30 characters, where the copy is used for public propaganda”, or the like.

To clearly describe differences between the to-be-recommended content and the recommendation message, a relationship between the to-be-recommended content and the recommendation message is clarified below. The to-be-recommended content is the core component of the recommendation message. However, directly pushing the to-be-recommended content to the public may not necessarily achieve good recommendation effects in terms of attracting clicks, views, and responses from the public. Therefore, the to-be-recommended content needs to be used as the core component to generate the recommendation message, thereby achieving a better recommendation effect in an expression manner that is more comprehensible and has a better propagation effect. Thus, the content conversion rate is higher, and more clicks, views, and responses are attracted from the public. The to-be-recommended content refers to content that needs to be delivered or recommended on the Internet, and the function of the recommendation message is to recommend the to-be-recommended content to the public to attract the public to click, view, and respond to the to-be-recommended content.

In operation 320, the seed attribute of the to-be-recommended content is predicted based on the to-be-recommended content description. The seed attribute of the to-be-recommended content is configured for reflecting a topic concept or related field involved in the to-be-recommended content description. Predicting the seed attribute of the to-be-recommended content based on the to-be-recommended content description aims to clarify the associated topic concept or field from the to-be-recommended content description so that the supplementary information corresponding to the to-be-recommended content description and the seed attribute may be retrieved in the subsequent operation.

In some specific embodiments, the seed attribute of the to-be-recommended content can be represented in the form of a key-value pair, for example, “{'category': game, ‘product’: A game}”, where “category” is a key, “game” is a value corresponding to “category”, “product” is a key, and “A game” is a value corresponding to “product”. There are many exemplary parameter types that can be used as keys, for example, “associated word” and “core highlight”. In addition, a value corresponds to a parameter type of a key. For example, if the key is “category”, a corresponding value may be “finance”, “game”, “car”, or the like. For another example, if the key is “product”, a corresponding value may be specifically “XX credit card”, “XX game”, “XX car”, or the like. For still another example, if the key is “core highlight”, a corresponding value may be “new album”, “no service fee”, “10% off”, “limited quantity”, “free membership”, or the like.

The seed attribute may be expressed in various forms according to the embodiments described herein and is not limited thereto.

In operation 330, information retrieval is performed in the information database based on the to-be-recommended content description and the seed attribute to obtain the supplementary information corresponding to the to-be-recommended content description and the seed attribute. In this embodiment of the present disclosure, the supplementary information corresponding to the to-be-recommended content description and the seed attribute may refer to various news information associated with the to-be-recommended content description and the seed attribute. The news information is associated with the to-be-recommended content description and the seed attribute, which may be that the news information belongs to the same field as the to-be-recommended content description and the seed attribute, or that the news information belongs to the same topic concept as the to-be-recommended content description and the seed attribute. The function of the information database is to perform further information expansion based on the to-be-recommended content description to obtain the supplementary information corresponding to the to-be-recommended content description and the seed attribute. In this way, the to-be-recommended content description and the corresponding supplementary information are subsequently integrated to generate the query message, and the query message is inputted into the first large-scale pre-trained language model to generate a corresponding recommendation message. The supplementary information has an abundant amount of information. Therefore, the to-be-recommended content description and the corresponding supplementary information are integrated to generate the query message, and then the query message is inputted into the first large-scale pre-trained language model, thereby helping to generate a recommendation message with higher quality.

In some specific embodiments, if the to-be-recommended content description is “All skins will be sold at a 20% discount during the XX game event; please generate a recommendation message for the XX game event”, the seed attribute includes “{‘category’: game, ‘product’: A game}”. Then, all skins of the A game including A1, A2, A3, . . . may be further retrieved from the information database according to the to-be-recommended content description and the seed attribute. If there is annotated information measuring popularity of each skin in the A game in the information database, a name of a skin that is relatively popular may be used as supplementary information corresponding to the to-be-recommended content description and the seed attribute, which helps to make the generated recommendation message easily attract the public to click, view, and respond. In this way, the quality of the recommendation message will be higher. In addition, according to the to-be-recommended content description and the seed attribute, an event duration of the XX game event may further be retrieved from the information database. If the event duration is used as the supplementary information corresponding to the to-be-recommended content description and the seed attribute, it is helpful to make the generated recommendation message easily reflect the participation of the public in the XX game event within an effective time. In this way, more participation of the public in the XX game event is facilitated, and the quality of the recommendation message is correspondingly improved.

There are various embodiments of performing information retrieval in the information database based on the to-be-recommended content description and the seed attribute to obtain the supplementary information corresponding to the to-be-recommended content description and the seed attribute. The implementations may include, but are not limited to, the foregoing specific embodiments.

In operation 340, the prompt template is populated with the to-be-recommended content description and the supplementary information to obtain the query message. The prompt template is configured for integrating the to-be-recommended content description and the supplementary information. The prompt template may include two to-be-populated fields. The two fields are configured to be filled with the to-be-recommended content description and the supplementary information, respectively. After the to-be-recommended content description and the supplementary information are obtained in the foregoing operations, the prompt template is populated with the to-be-recommended content description and the supplementary information to obtain the query message. The query message is a prompt configured for conveying a recommendation message generation requirement to a large-scale pre-trained language model.

The prompt is text information having a guiding function. In the process of applying the large-scale pre-trained language model to the generation of the recommendation message, to obtain the recommendation message corresponding to the to-be-recommended content description and the supplementary information, a guiding text needs to be formulated in advance to convey the recommendation message generation requirement to the large-scale pre-trained language model. If a guiding text is randomly formulated in the process of conveying a preset requirement to the large-scale pre-trained language model, it is difficult for the guiding text obtained in this way to meet an expression paradigm of the large-scale pre-trained language model. Therefore, in some embodiments of the present disclosure, a prompt meeting the expression paradigm of the large-scale pre-trained language model needs to be added based on a commentary sentence to generate the guiding text. In this way, in the process of applying the large-scale pre-trained language model to the generation of the recommendation message, a recommendation message with relatively high quality may be obtained.

In some specific embodiments, the prompt template may be “known information: {supplementary information corresponding to to-be-recommended content description and seed attribute}; generate a recommendation message with reference to the known information according to the following requirement: {recommendation request containing to-be-recommended content description}”. After the to-be-recommended content description “All skins of the A game are sold at a 20% discount, please generate a recommendation copy within 30 characters” and the supplementary information “Skins with relatively high sales in the A game include A1, A2, and A3” are obtained in the foregoing operations, the prompt template may be populated with the to-be-recommended content description and the supplementary information to obtain the query message “known information: {Skins with relatively high sales in the A game include A1, A2, and A3}; generate a recommendation message with reference to the known information according to the following requirement: {All skins of the A game are sold at a 20% discount, please generate a recommendation copy within 30 characters}”.

There are various implementations of populating the prompt template with the to-be-recommended content description and the supplementary information to obtain the query message. The implementations may include, but are not limited to, the foregoing specific embodiments.

In operation 350, based on the query message, the recommendation message of the to-be-recommended content is generated using the first large-scale pre-trained language model. The query message is a prompt configured for conveying a recommendation message generation requirement to a large-scale pre-trained language model. Therefore, generating, based on the query message, the recommendation message using the first large-scale pre-trained language model may be specifically: inputting the query message into the first large-scale pre-trained language model, and generating, using a powerful language representation capability of the large-scale pre-trained language model, the recommendation message according to the recommendation message generation requirement conveyed by the query message. In this way, the generation efficiency is high, and the generated recommendation message has a high quality.

In some specific embodiments, the first large-scale pre-trained language model used in this embodiment of the present disclosure may include, but is not limited to, models such as BERT, GPT-2, GPT3, ChatGPT, and GPT4.

After the recommendation message of the to-be-recommended content is obtained, the recommendation message may further be displayed to deliver the recommendation message of the to-be-recommended content to a target object.

If a module that generates the recommendation message and a module that displays the recommendation message are integrated on the same device, the recommendation message may be displayed directly using a display module. If the module that generates the recommendation message and the module that displays the recommendation message are not integrated on the same device, the recommendation message needs to be transmitted to a recommendation module of another device so that the recommendation message can be displayed. Therefore, “displaying the recommendation message” is to be equally understood as “enabling the recommendation message to be displayed”.

In some specific embodiments, after the object terminal A is controlled to perform the foregoing operation 310 to operation 350, the recommendation message “A1, A2, and A3 skins are on sale! Enjoy a 20% discount on skins during the XX game event!” may be generated. To enable the foregoing generated recommendation message to be displayed on the object terminal B, a display instruction containing the recommendation message may be generated according to the recommendation message, and then the display instruction is transmitted to the object terminal B so that the object terminal B displays, in a manner such as a notification bar, a pop-up window, or a short message, content of the recommendation message “A1, A2, and A3 skins are on sale! Enjoy a 20% discount on skins during the XX game event!”.

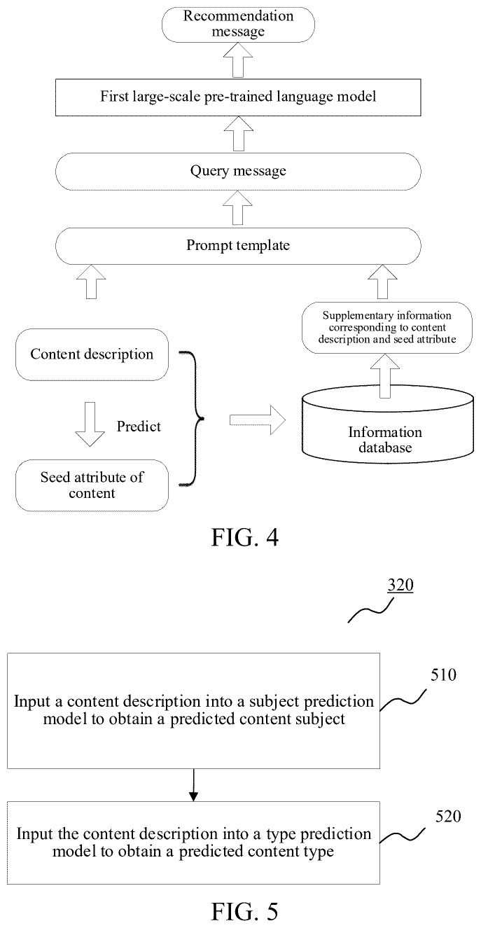

FIG. 4 is an exemplary diagram of a recommendation message generation method for content recommendation according to the present disclosure. It may be clear from FIG. 4 that, in the recommendation message generation method in the present disclosure, the recommendation request containing the to-be-recommended content description needs to be first acquired, and then the seed attribute of the to-be-recommended content is predicted based on the recommendation request. Further, based on the recommendation request containing the to-be-recommended content description and the seed attribute of the to-be-recommended content, the supplementary information corresponding to the to-be-recommended content description and the seed attribute is retrieved from the information database. Still further, the prompt template is populated with the to-be-recommended content description, and the supplementary information corresponding to the to-be-recommended content description and the seed attribute, and then the query message is obtained. Then, the query message is inputted into the first large-scale pre-trained language model, and a corresponding recommendation message is generated using a powerful language representation capability of the first large-scale pre-trained language model. In the foregoing recommendation message generation method, the query message includes the to-be-recommended content description, and the supplementary information corresponding to the to-be-recommended content description and the seed attribute. Therefore, the query message can provide a rich and full amount of information. When the query message is inputted into the first large-scale pre-trained language model, the first large-scale pre-trained language model can be guided to complete a task of generating the recommendation message with higher quality, thereby improving the accuracy of generating the recommendation message and the recommendation conversion rate.

This embodiment of the present disclosure is shown through operation 310 to operation 350. In the present disclosure, instead of directly inputting the to-be-recommended content description into the neural network model to generate the recommendation message, the seed attribute is first acquired from the to-be-recommended content description, the information database is searched according to the to-be-recommended content description and the seed attribute to find the supplementary information corresponding to the to-be-recommended content description and the seed attribute, and then the query message generated by populating the prompt template with the to-be-recommended content description and the supplementary information is inputted into the first large-scale pre-trained language model to generate the recommendation message. In this case, the first large-scale pre-trained language model not only generates the recommendation message according to the to-be-recommended content description, but also considers the supplementary information retrieved according to the seed attribute. The supplementary information has a relatively large limiting effect when the first large-scale pre-trained language model generates the recommendation message, thereby improving the accuracy of generating the recommendation message. Thus, the generated recommendation message is easier to be clicked by or interacted with an object, thereby improving the recommendation conversion rate.

Since operation 310 and operation 350 have been described in sufficient detail above, operation 320 to operation 350 are described in detail below.

### Detailed Description of Operation 320

Referring to FIG. 5, in some embodiments, the seed attribute may include a to-be-recommended content subject and a to-be-recommended content type. Operation 320 may include, but is not limited to, operation 510 to operation 520 described below.

Operation 510: Input the to-be-recommended content description into a subject prediction model to obtain a predicted to-be-recommended content subject.

Operation 520: Input the to-be-recommended content description into a type prediction model to obtain a predicted to-be-recommended content type.

Operation 510 to operation 520 are described in detail below.

In operation 510, the to-be-recommended content description is inputted into the subject prediction model to obtain the predicted to-be-recommended content subject. The to-be-recommended content subject refers to a main or key component of the to-be-recommended content, and the component is configured for reflecting a topic concept or related field involved in the to-be-recommended content description. The to-be-recommended content subject, as the main or key component of the to-be-recommended content, discloses the topic concept or related field involved in the to-be-recommended content. The subject prediction model is an artificial intelligence model configured to determine the to-be-recommended content subject from the to-be-recommended content description. The subject prediction model may be a natural language model. Semantic recognition is performed on the to-be-recommended content description using the subject prediction model to determine the component of the to-be-recommended content description that discloses the topic concept or the related field, and the component is the to-be-recommended content subject.

In operation 520, the to-be-recommended content description is inputted into the type prediction model to obtain the predicted to-be-recommended content type. The to-be-recommended content type is configured for representing a topic concept or related field to which the to-be-recommended content specifically belongs. The to-be-recommended content subject refers to a main or key component of the to-be-recommended content, and the component is configured for reflecting a topic concept or related field involved in the to-be-recommended content description. The to-be-recommended content type is further configured for representing the topic concept or related field to which the to-be-recommended content specifically belongs. Therefore, the to-be-recommended content subject may correspond to the to-be-recommended content type. When there are multiple to-be-recommended content subjects, each to-be-recommended content subject may further have a corresponding to-be-recommended content type. The type prediction model is an artificial intelligence model configured to determine the to-be-recommended content type from the to-be-recommended content description. The type prediction model may be a natural language model. Semantic recognition is performed on the to-be-recommended content description through the type prediction model to determine the topic concept or related field specifically involved in the to-be-recommended content description. The determined topic concept or related field is the to-be-recommended content type.

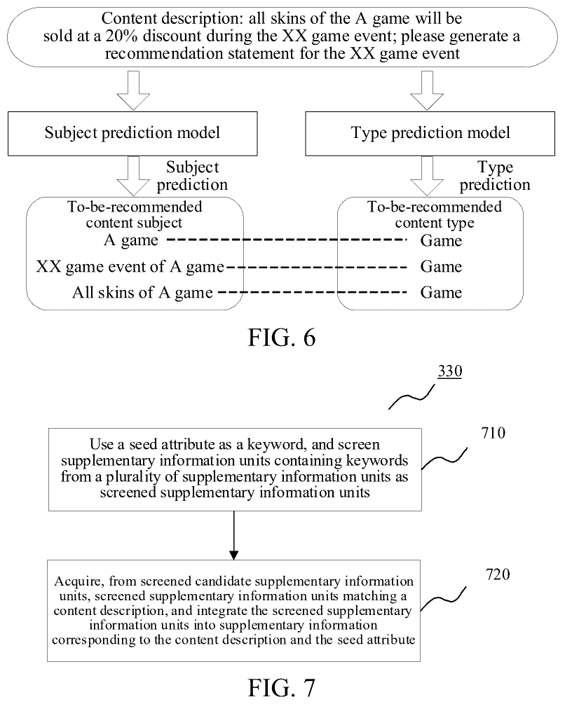

Referring to FIG. 6, in some specific embodiments, the to-be-recommended content description may be specifically “All skins of the A game will be sold at a 20% discount during the XX game event; please generate a recommendation message for the XX game event”. In the to-be-recommended content description shown above, a main component that discloses the topic concept or related field includes “A game”, “XX game event”, and “all skins”. Therefore, the to-be-recommended content description is inputted into the subject prediction model, and semantic recognition is performed on the to-be-recommended content description through the subject prediction model to determine to-be-recommended content subjects “A game”, “XX game event of A game”, and “all skins of A game”. The to-be-recommended content subjects are “A game”, “XX game event of A game”, and “all skins of A game”, and the disclosed topic concepts or related fields are all associated with “game”. Therefore, to-be-recommended content types corresponding to “A game”, “XX game event of A game”, and “all skins of A game” are all “game”.

In some specific embodiments, a name of the A game, a name of the B movie and television work, and a name of the C book may be the same. In this case, the to-be-recommended content type determined by the type prediction model based on the to-be-recommended content helps to frame a specific field to which the name belongs, and defines a scope of subsequent retrieval of the supplementary information.

In embodiments of the present disclosure shown in operation 510 to operation 520, the subject prediction model can determine, based on the to-be-recommended content description, the to-be-recommended content subject that is in the to-be-recommended content description and discloses the topic concept or the related field. The type prediction model can predict, based on the to-be-recommended content description, a topic concept or related field to which the to-be-recommended content specifically belongs, as the to-be-recommended content type. In an embodiment in which the seed attribute includes the to-be-recommended content subject and the to-be-recommended content type, supplementary information retrieved in the subsequent operation for the to-be-recommended content description and the seed attribute is more accurate, which helps to provide the query message with a rich and full amount of information with a relatively clear knowledge field. When the query message is inputted into the first large-scale pre-trained language model, the first large-scale pre-trained language model can be guided to complete the task of generating the recommendation message with higher quality, thereby further improving the accuracy of generating the recommendation message and the recommendation conversion rate.

### Detailed Description of 330

Referring to FIG. 7, in some embodiments, the information database includes a plurality of supplementary information units. Operation 330 may include, but is not limited to, operation 710 to operation 720 described below.

Operation 710: Use the seed attribute as a keyword, and screen supplementary information units containing keywords from the plurality of supplementary information units as screened supplementary information units.

Operation 720: Acquire, from the screened supplementary information units, screened supplementary information units matching the to-be-recommended content description, and integrate the screened supplementary information units into the supplementary information corresponding to the to-be-recommended content description and the seed attribute.

Operation 710 to operation 720 are described in detail below.

In operation 710, the seed attribute is used as the keyword, and the supplementary information units containing keywords are screened from the plurality of supplementary information units as the screened supplementary information units. The information database includes information and news in a plurality of knowledge fields, and the supplementary information unit refers to a data unit that stores information and news in the information database.

The information database is used as a database that includes information and news in various knowledge fields, and is constructed in various manners.

In some specific embodiments, a plurality of knowledge fields may be determined based on entry classification of some search engines on the Internet, and then information and news of a corresponding knowledge field are populated based on specific content under each entry.

In other specific embodiments, some specific knowledge fields may further be determined first, and then information and news that are frequently clicked, viewed, and responded to in these knowledge fields are determined in a manner of event tracking analysis. Then, the information and news are integrated to construct an information database. The event tracking analysis is a data acquisition method for website analysis and refers to the related art and its implementation process of attaching data acquisition program code to functional program code at an “operation node” where data acquisition is required, and capturing, processing, and transmitting an object behavior or event on the operation node.

According to some exemplary embodiments of the present disclosure, after information and news corresponding to each knowledge field are determined, data in the information database may further be updated in real time based on real-time messages appearing on the Internet. In an information database updated in real time, the richness of information and news is higher, and there is a relatively small amount of outdated information and news. Therefore, supplementary information retrieved from such an information database has a richer and more accurate amount of information.

The seed attribute of the to-be-recommended content is configured for reflecting a topic concept or related field involved in the to-be-recommended content description. The information database includes information and news in a plurality of knowledge fields and supplementary information units in various knowledge fields. Therefore, to determine the supplementary information associated with the to-be-recommended content from the plurality of supplementary information units, the seed attribute needs to be used as the keyword first, and the plurality of supplementary information units are screened to determine the supplementary information units containing keywords as the screened supplementary information units.

In operation 720, the screened supplementary information units matching the to-be-recommended content description are acquired from the screened supplementary information units and integrated into the supplementary information corresponding to the to-be-recommended content description and the seed attribute. According to operation 710, the supplementary information units containing keywords may be screened as the screened supplementary information units. The supplementary information unit contains the keyword, which does not mean that the supplementary information unit helps to expand the amount of information for the to-be-recommended content. To obtain supplementary information of relatively high quality, the screened supplementary information units matching the to-be-recommended content description further need to be acquired from a plurality of screened supplementary information units. Still further, the screened supplementary information unit matching the to-be-recommended content description are integrated to obtain the supplementary information corresponding to the to-be-recommended content description and the seed attribute.

In embodiments of the present disclosure shown in operation 710 to operation 720, the seed attribute is used as the keyword, and the supplementary information units containing keywords are screened from the plurality of supplementary information units as the screened supplementary information units. The screened supplementary information units matching the to-be-recommended content description are acquired and integrated into the supplementary information corresponding to the to-be-recommended content description and the seed attribute. The supplementary information retrieved in this way is more accurate, which helps to provide the query message with a rich and full amount of information with a relatively clear knowledge field. When the query message is inputted into the first large-scale pre-trained language model, the first large-scale pre-trained language model can be guided to complete the task of generating the recommendation message with higher quality, thereby further improving the accuracy of generating the recommendation message and the recommendation conversion rate.

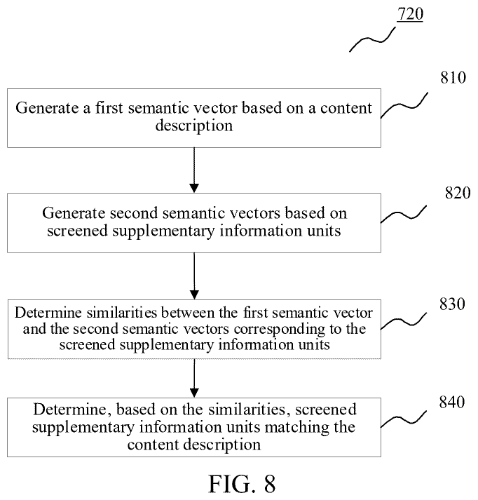

Referring to FIG. 8, in some exemplary embodiments of the present disclosure, operation 720 may include, but is not limited to, operation 810 to operation 840 described below.

Operation 810: Generate a first semantic vector based on the to-be-recommended content description.

Operation 820: Generate second semantic vectors based on the screened supplementary information units.

Operation 830: Determine similarities between the first semantic vector and the second semantic vectors corresponding to the screened supplementary information units.

Operation 840: Determine, based on the similarities, the screened supplementary information units matching the to-be-recommended content description.

Operation 810 to operation 840 are described in detail below.

In operation 810 to operation 820, the first semantic vector is first generated based on the to-be-recommended content description, and then the second semantic vectors are generated based on the screened supplementary information units. The to-be-recommended content refers to content that needs to be delivered or recommended on the Internet, and the to-be-recommended content description is a description of the to-be-recommended content. The supplementary information unit refers to a data unit that stores information and news in the information database. Both the to-be-recommended content description and the supplementary information unit may be data in a text form. If the to-be-recommended content description and the supplementary information unit are associated with each other in text semantics, the screened supplementary information unit matches the to-be-recommended content description. Therefore, to define which screened supplementary information units match the to-be-recommended content description, the to-be-recommended content description and the screened supplementary information units need to be converted from text symbol representations into vectors in semantic space to facilitate the comparison of the two. The to-be-recommended content description is converted into a vector in the semantic space, i.e., the first semantic vector. The screened supplementary information unit is converted into a vector in the semantic space, i.e., the second semantic vector. The text symbol representation may be converted into the vector in the semantic space using the word segmentation technology in combination with the natural language processing model.

In operation 830 to operation 840, the similarities between the first semantic vector and the second semantic vectors corresponding to the screened supplementary information units are first determined, and then the screened supplementary information units matching the to-be-recommended content description are determined based on the similarities. After the first semantic vector is generated based on the to-be-recommended content description, and the second semantic vectors are generated based on the screened supplementary information units, the second semantic vectors may be compared with the first semantic vector to obtain the similarities between the first semantic vector and the second semantic vectors. The similarity may reflect a degree of association between semantics of the first semantic vector and semantics of the second semantic vector and further reflect a matching degree between the screened supplementary information unit and the to-be-recommended content description. Usually, a higher similarity indicates a higher degree of association between the semantics of the first semantic vector and the semantics of the second semantic vector, and a higher matching degree between the screened supplementary information unit and the to-be-recommended content description. Therefore, the screened supplementary information units matching the to-be-recommended content description may be determined based on the similarities.

In some embodiments, the similarity between the first semantic vector and the second semantic vector may be represented through a distance between the first semantic vector and the second semantic vector, or may be represented through a cosine similarity between the first semantic vector and the second semantic vector. Based on this, an exemplary implementation of operation 830 may be: calculating the distance between the first semantic vector and the second semantic vector, or calculating the cosine similarity between the first semantic vector and the second semantic vector based on the first semantic vector and the second semantic vector, to determine whether the semantics represented by the first semantic vector is associated with the semantics represented by the second semantic vector, thereby defining a screened supplementary information unit matching the to-be-recommended content description.

The distance between the first semantic vector and the second semantic vector may be a Euclidean distance, a Manhattan distance, or a distance of another type. This is not limited in this embodiment of the present disclosure.

In some exemplary embodiments of the present disclosure, when the similarity between the first semantic vector and the second semantic vector is represented through the distance between the first semantic vector and the second semantic vector, a smaller distance between the first semantic vector and the second semantic vector indicates a higher semantic similarity between the to-be-recommended content description and the screened supplementary information unit. Therefore, a distance threshold may be set to define which supplementary information units are associated with the to-be-recommended content description in text semantics. In this way, second semantic vectors whose distances to the first semantic vector are less than the distance threshold may be determined, and the screened supplementary information units corresponding to the second semantic vectors may be determined to match the to-be-recommended content description.

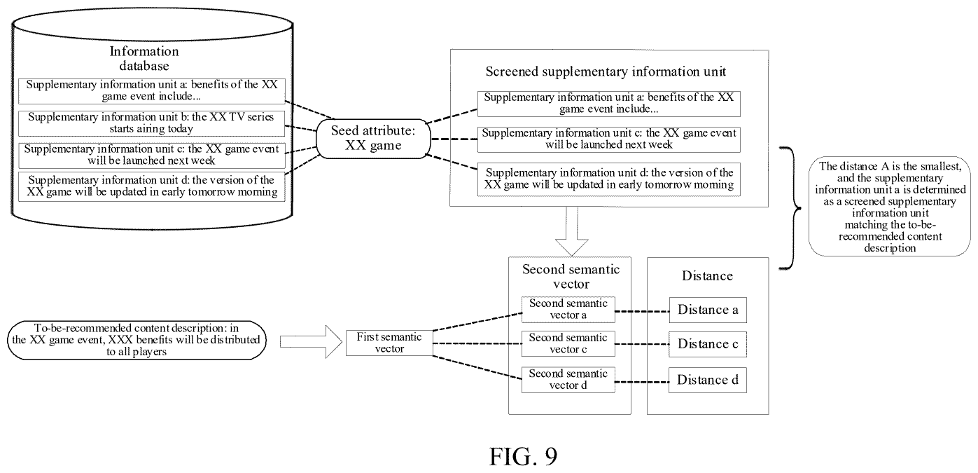

In embodiments of the present disclosure shown in operation 810 to operation 840, to define which screened supplementary information units match the to-be-recommended content description, the to-be-recommended content description and the screened supplementary information units need to be converted from the text symbol representations into the vectors in the semantic space. Then, the similarities between the first semantic vector and the second semantic vectors corresponding to the screened supplementary information units are determined, and then the screened supplementary information units matching the to-be-recommended content description are determined based on the similarities. In this way, more accurate supplementary information may be retrieved, which helps to provide the query message with a rich and full amount of information with a relatively clear knowledge field. When the query message is inputted into the first large-scale pre-trained language model, the first large-scale pre-trained language model can be guided to complete the task of generating the recommendation message with higher quality, thereby further improving the accuracy of generating the recommendation message and the recommendation conversion rate. FIG. 9 is an exemplary diagram of performing information retrieval in the information database based on the to-be-recommended content description and the seed attribute to obtain the supplementary information corresponding to the to-be-recommended content description and the seed attribute. The to-be-recommended content description is “In the XX game event, XXX benefits will be distributed to all players”, and the information database includes a supplementary information unit a [Benefits of the XX game event include . . . ], a supplementary information unit b [The XX TV series starts airing today], a supplementary information unit c [The XX game event will be launched next week], and a supplementary information unit d [The version of the XX game will be updated in early tomorrow morning]. When the seed attribute is “XX game”, since XX in the supplementary information unit b refers to “XX TV series”, and XX in the supplementary information unit a, the supplementary information unit c, and the supplementary information unit d refers to “XX game”, the supplementary information unit b is screened out, and the supplementary information unit a, the supplementary information unit c, and the supplementary information unit d are reserved. Further, the first semantic vector is generated based on the to-be-recommended content description “In the XX game event, XXX benefits will be distributed to all players”. In addition, a second semantic vector a is generated based on the supplementary information unit a [Benefits of the XX game event include . . . ], a second semantic vector b is generated based on the supplementary information unit b [The XX TV series starts airing today], and a second semantic vector d is generated based on the supplementary information unit d [The version of the XX game will be updated in early tomorrow morning]. Still further, a distance a between the first semantic vector and the second semantic vector a, a distance b between the first semantic vector and the second semantic vector b, and a distance d between the first semantic vector and the second semantic vector d are determined. Since the distance a between the first semantic vector and the second semantic vector a is the smallest, the to-be-recommended content description and the supplementary information unit a are semantically associated, and the supplementary information unit a may be further determined as a screened supplementary information unit matching the to-be-recommended content description.

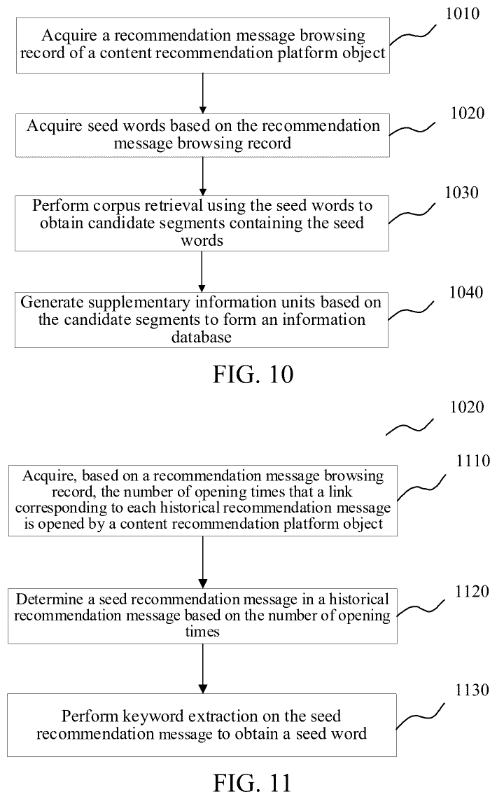

Referring to FIG. 10, in some embodiments provided in the present disclosure, the information database may be generated through the following operation 1010 to operation 1040.

Operation 1010: Acquire a recommendation message browsing record of a content recommendation platform object.

Operation 1020: Acquire seed words based on the recommendation message browsing record.

Operation 1030: Perform corpus retrieval using the seed words to obtain candidate segments containing the seed words.

Operation 1040: Generate the supplementary information units based on the candidate segments to form the information database.

Operation 1010 to operation 1040 are described in detail below.

In operation 1010, the recommendation message browsing record of the content recommendation platform object is acquired. A content recommendation platform refers to an Internet platform configured to recommend content on the Internet, and may alternatively be considered as an Internet platform on which various recommendation messages are delivered. The recommendation message browsing record of the content recommendation platform object may be specifically a browsing record left after browsing the recommendation messages on the content recommendation platform using the content recommendation platform object. When a recommendation message browsing record of an object needs to be acquired in this embodiment of the present disclosure, individual permission or individual consent of the object is obtained through a pop-up window or jumping to a confirmation page. After the individual permission or the individual consent of the object is explicitly obtained, the recommendation message browsing record in this embodiment of the present disclosure is acquired.

In operation 1020, the seed words are acquired based on the recommendation message browsing record. The seed word refers to a word representing a topic concept in the recommendation message browsing record, and may be considered as a component of providing feature information for a recommendation message. Which words in the recommendation message browsing record can represent a topic concept and provide feature information for the recommendation message may be determined in multiple manners.

In some specific embodiments, the seed words are acquired based on the recommendation message browsing record and may be determined through a seed word recognition model. The seed word recognition model refers to an artificial intelligence model configured to recognize a seed word from a recommendation message browsing record. The seed word recognition model may be a natural language model. Semantic recognition is performed on the recommendation message browsing record through the seed word recognition model to determine a word that represents a topic concept and provides feature information for the recommendation message in the recommendation message browsing record, and the recognized word may be determined as the seed word.

In operation 1030, corpus retrieval is performed using the seed words to obtain the candidate segments containing the seed words. The seed word refers to a word representing a topic concept in the recommendation message browsing record. Therefore, corpus retrieval is performed using the seed words to expand a corpus of the topic concept to which the seed words belong, to obtain a plurality of candidate segments containing the seed words. There are various implementations of performing corpus retrieval using the seed word.

In some specific embodiments, performing corpus retrieval using the seed words may be: inputting the seed words into various search engines deployed on the Internet to obtain the candidate segments containing the seed words. In other specific embodiments, corpus retrieval is performed using the seed words. Alternatively, the seed words may be inputted into a large-scale pre-trained language model to obtain, using a powerful language representation capability of the large-scale pre-trained language model, candidate segments containing the seed words in the terminal. The large-scale pre-trained language model that can be configured for corpus retrieval may include, but is not limited to, models such as BERT, GPT-2, GPT3, ChatGPT, and GPT4. The implementation of performing corpus retrieval using the seed word is not limited to the foregoing example.

In operation 1040, the supplementary information units are generated based on the candidate segments to form the information database. After the candidate segments containing the seed words are obtained, a corpus expanded based on the topic concept to which the seed words belong is obtained. Then, the supplementary information units may be further generated based on the candidate segments to form the information database. The information database generated in this way can perform further information expansion based on the to-be-recommended content description to obtain the supplementary information corresponding to the to-be-recommended content description and the seed attribute.

In embodiments of the present disclosure shown in operation 1010 to operation 1040, an information database configured for performing information expansion on the to-be-recommended content description may be generated. In the foregoing process of generating the information database, the seed word is determined from the recommendation message browsing record of the content recommendation platform object and then used as a clue to perform corpus retrieval to provide a target corpus for the construction of the information database. This implementation provides logical and clear operations and is a highly efficient information database generation method.

Referring to FIG. 11, in some embodiments provided in the present disclosure, operation 1020 may include, but is not limited to, operation 1110 to operation 1130 described below.

Operation 1110: Acquire, based on the recommendation message browsing record, the number of opening times that a link corresponding to each historical recommendation message is opened by the content recommendation platform object.

Operation 1120: Determine a seed recommendation message in the historical recommendation message based on the number of opening times.

Operation 1130: Perform keyword extraction on the seed recommendation message to obtain the seed word.

Operation 1110 to operation 1130 are described in detail below.

The recommendation message browsing record may be specifically a browsing record left after browsing the recommendation messages on the content recommendation platform using all content recommendation platform objects. These browsed recommendation messages may be referred to as historical recommendation messages. The seed word refers to a word representing a topic concept in the recommendation message browsing record and provides feature information for the historical recommendation message.

According to some embodiments provided in the present disclosure, a large number of historical recommendation messages may be determined from the recommendation message browsing record. If the large number of historical recommendation messages are all configured for determining seed words, the number of seed words in niche and unpopular fields may account for an excessive proportion among all seed words. In other embodiments, the large number of historical recommendation messages are all configured for determining seed words, leading to the number of seed words in public and popular topics accounting for an excessive proportion among all seed words. In the two cases, when the information database is configured for performing information expansion for the to-be-recommended content description, the efficiency of retrieving the supplementary information corresponding to the to-be-recommended content description and the seed attribute is low. To resolve this problem, one type of embodiment is shown in operation 1110 to operation 1130 of the present disclosure.

In operation 1110 to operation 1120, based on the recommendation message browsing record, the number of opening times that the link corresponding to each historical recommendation message is opened by the content recommendation platform object is acquired, and then the seed recommendation message is determined in the historical recommendation message based on the number of opening times. A larger number of opening times that a link corresponding to a historical recommendation message in the recommendation message browsing record is opened by the content recommendation platform object indicates a larger number of times that the historical recommendation message is clicked, viewed, and responded to by the public, and a larger number of audiences in the knowledge field to which the historical recommendation message belongs. A smaller number of opening times that a link corresponding to a historical recommendation message in the recommendation message browsing record is opened by the content recommendation platform object indicates a smaller number of times that the historical recommendation message is clicked, viewed, and responded to by the public, and a smaller number of audiences in the knowledge field to which the historical recommendation message belongs. An information database with relatively high quality needs to include a plurality of knowledge fields in a limited capacity space, and each knowledge field also needs to have a considerable number of candidate segments. Therefore, as a basis for retrieving the candidate segment, the seed word needs to be selected in each knowledge field. Therefore, the number of opening times that the link corresponding to each historical recommendation message in the recommendation message browsing record is opened by the content recommendation platform object may be used as a basis for determining knowledge fields of which historical recommendation messages having a large number of audiences and knowledge fields of which historical recommendation messages having a small number of audiences. In this way, the seed recommendation message may be determined according to requirements.

In operation 1130, keyword extraction is performed on the seed recommendation message to obtain the seed word. After the seed recommendation message is clarified, keyword extraction may be performed on the seed recommendation message to find a word that can represent a topic concept, thereby obtaining the seed word.

In embodiments of the present disclosure shown in operation 1110 to operation 1130, the seed recommendation message may be determined according to the number of opening times that the link corresponding to each historical recommendation message in the recommendation message browsing record is opened by the content recommendation platform object, and keyword extraction is further performed on the seed recommendation message to obtain the seed word. In this way, the corresponding seed word may be properly determined in each field so that when the information database is configured for performing information expansion for the to-be-recommended content description, the supplementary information corresponding to the to-be-recommended content description and the seed attribute may be retrieved more efficiently.

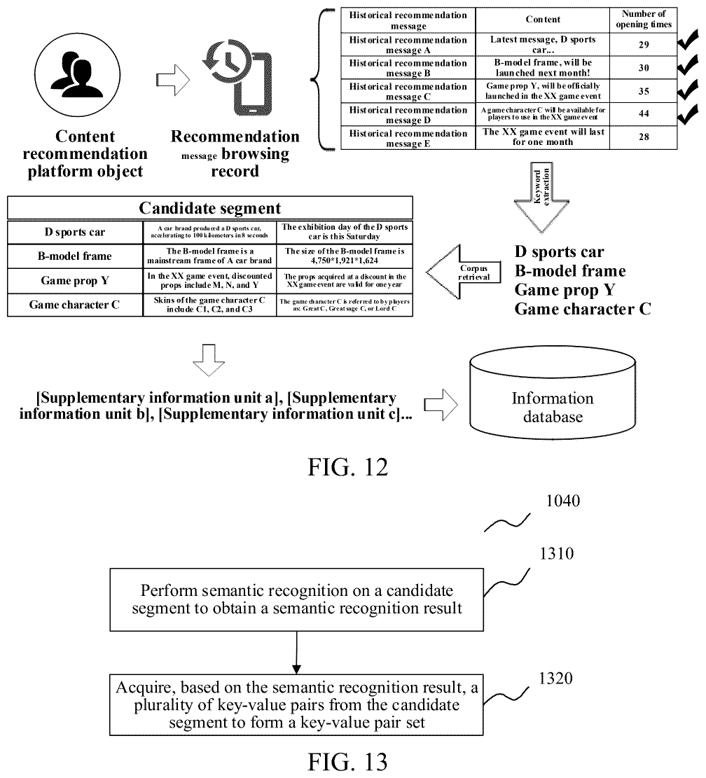

Referring to FIG. 12, the recommendation message browsing record of the content recommendation platform object is first acquired.

The recommendation message browsing record specifically includes: a historical recommendation message A [Latest message, D sports car . . . ], a historical recommendation message B [B-model frame, will be launched next month!], a historical recommendation message C [Game prop Y, will be officially launched in the XX game event], a historical recommendation message D [A game character C will be available for players to use in the XX game event], and a historical recommendation message E [The XX game event will last for one month].

Based on the recommendation message browsing record, the number of opening times that the link corresponding to each historical recommendation message is opened by the content recommendation platform object is further acquired.

The number of opening times of the historical recommendation message A is 29, the number of opening times of the historical recommendation message B is 30, the number of opening times of the historical recommendation message C is 35, the number of opening times of the historical recommendation message D is 44, and the number of opening times of the historical recommendation message E is 28. Further, in this embodiment, four historical recommendation messages with a relatively large number of opening times are selected as seed recommendation messages, i.e., the historical recommendation message A, the historical recommendation message B, the historical recommendation message C, and the historical recommendation message D.

Still further, keyword extraction is performed on the seed recommendation message to obtain the seed word.

A seed word extracted for the historical recommendation message A [Latest message, D sports car . . . ] is “D sports car”, a seed word extracted for the historical recommendation message B [B-model frame, will be launched next month!] is “B-model frame”, a seed word extracted for the historical recommendation message C [Game prop Y, will be officially launched in the XX game event] is “game prop Y”, and a seed word extracted for the historical recommendation message D [A game character C will be available for players to use in the XX game event] is “game character C”.

Further, corpus retrieval is performed using the seed words to obtain the candidate segments containing the seed words.

Corpus retrieval is performed using “D sports car” to obtain a candidate segment [A car brand produced a D sports car, accelerating to 100 kilometers in 8 seconds] and a candidate segment [The exhibition day of the D sports car is this Saturday]. Corpus retrieval is performed using the “B-model frame” to obtain a candidate segment [The B-model frame is a mainstream frame of A car brand] and a candidate segment [The size of the B-model frame is 4,750*1,921*1,624]. Corpus retrieval is performed using “game prop Y” to obtain a candidate segment [In the XX game event, discounted props include M, N, and Y] and a candidate segment [The props acquired at a discount in the XX game event are valid for one year]. Corpus retrieval is performed using “game character C” to obtain a candidate segment [Skins of the game character C include C1, C2, and C3] and a candidate segment [The game character C is referred to by players as: Great C, Great sage C, or Lord C].

Based on the candidate segments obtained in the foregoing process, [supplementary information unit a], [supplementary information unit b], [supplementary information unit c], may be generated to form the information database.

Referring to FIG. 13, in some embodiments of the present disclosure, the supplementary information unit is a key-value pair set. Generating the supplementary information units based on the candidate segments in operation 1040 may include, but is not limited to, operation 1310 to operation 1320 described below.

Operation 1310: Perform semantic recognition on the candidate segment to obtain a semantic recognition result.

Operation 1320: Acquire, based on the semantic recognition result, a plurality of key-value pairs from the candidate segment to form the key-value pair set.

Operation 1310 to operation 1320 are described in detail below.

In operation 1310 to operation 1320, semantic recognition is first performed on the candidate segment to obtain the semantic recognition result, and then based on the semantic recognition result, the plurality of key-value pairs are acquired from the candidate segment to form the key-value pair set. The key-value pair acquired from the candidate segment may be specifically a data pair formed by a pair of key information and value information. The key information is configured for representing a text semantic attribute of a text, and the value information is configured for representing a text semantic attribute value of a text. A plurality of key-value pairs are constructed based on the text semantic attribute and the text semantic attribute value of the candidate segment to form a key-value pair set, so as to form a data type that is convenient for retrieval in the information database.

In some specific embodiments, text semantic attributes represented by the key information may be “category”, “subject”, and “associated word”. Specifically, the “category” is a topic concept or related art involved in the candidate segment. The “subject” is a specific object involved in the candidate segment. The “associated word” is associated information involved in the candidate segment.

In some specific embodiments, the text semantic attribute value represented by the value information corresponds to the text semantic attribute represented by the key information. For example, when a text semantic attribute represented by the key information is “category”, a text semantic attribute value corresponding to the “category” may be “game”, “car”, “music”, or “photography”. When a text semantic attribute represented by the key information is “subject”, a text semantic attribute value corresponding to the “subject” may be a game, a prop, a plant, or a product. When the text semantic attribute represented by the key information is “associated word”, a text semantic attribute value corresponding to the “associated word” may be a release day of a game, a size of a product, or the like.

There are various types of key-value pairs. Therefore, types of the key information and the value information are not limited to the foregoing specific embodiments.

In some exemplary embodiments, semantic recognition may be specifically performed on the candidate segment using a semantic key-value pair extraction model. The semantic key-value pair extraction model refers to an artificial intelligence model configured to extract key-value pairs from the candidate segment. The seed word recognition model may be a natural language model. Semantic recognition is performed on the candidate segment using the seed word recognition model to determine what text semantic attribute the text in the candidate segment has, and what text semantic attribute value corresponding to the text semantic attribute is. In this way, a plurality of key-value pairs may be acquired from the candidate segment.

In embodiments of the present disclosure shown in operation 1310 to operation 1320, in an embodiment in which the information database contains the key-value pair set, since data of the key-value pair type helps to improve the retrieval efficiency, the information database is configured for performing information expansion on the to-be-recommended content description so that the supplementary information corresponding to the to-be-recommended content description and the seed attribute may be obtained more efficiently.

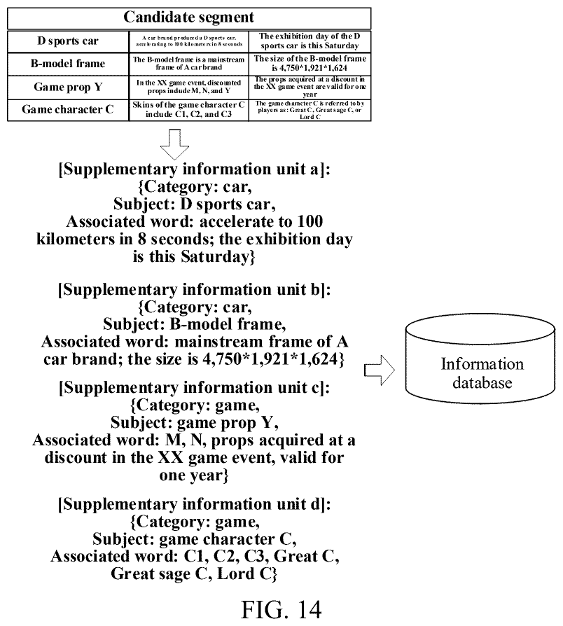

Referring to FIG. 14, in some specific embodiments, corpus retrieval is performed using “D sports car” to obtain a candidate segment [A car brand produced a D sports car, accelerating to 100 kilometers in 8 seconds] and a candidate segment [The exhibition day of the D sports car is this Saturday]. Corpus retrieval is performed using the “B-model frame” to obtain a candidate segment [The B-model frame is a mainstream frame of A car brand] and a candidate segment [The size of the B-model frame is 4,750*1,921*1,624]. Corpus retrieval is performed using “game prop Y” to obtain a candidate segment [In the XX game event, discounted props include M, N, and Y] and a candidate segment [The props acquired at a discount in the XX game event are valid for one year]. Corpus retrieval is performed using “game character C” to obtain a candidate segment [Skins of the game character C include C1, C2, and C3] and a candidate segment [The game character C is referred to by players as: Great C, Great sage C, or Lord C].

Further, semantic recognition is performed on the candidate segment to obtain the semantic recognition result, and then based on the semantic recognition result, the plurality of key-value pairs are acquired from the candidate segment to form the key-value pair set. Specifically,

semantic recognition is performed on the candidate segment [A car brand produced a D sports car, accelerating to 100 kilometers in 8 seconds] and the candidate segment [The exhibition day of the D sports car is this Saturday]. The topic concept or related field involved in the candidate segment is cars, and specifically, D sports car is involved. D sports car accelerates to 100 kilometers in 8 seconds, and the exhibition day of the D sports car is this Saturday. Based on this, the following key-value pair used as [supplementary information unit a] is formed: {“category”: car}, where the key information is “category”, and the value information is [car]; {“subject”: D sports car}, where the key information is “subject”, and the value information is [D sports car]; and {“associated word”: accelerate to 100 kilometers in 8 seconds; the exhibition day is this Saturday}, where the key information is “associated word”, and the value information is [accelerate to 100 kilometers in 8 seconds; the exhibition day is this Saturday].

Semantic recognition is performed on the candidate segment [The B-model frame is a mainstream frame of A car brand] and the candidate segment [The size of the B-model frame is 4,750*1,921*1,624]. The topic concept or related field involved in the candidate segment is cars, and specifically, the B-model frame is involved. The B-model frame is the mainstream frame of A car brand, and the size of the B-model frame is 4,750*1,921*1,624. Based on this, the following key-value pair used as [supplementary information unit b] is formed: {“category”: car}, where the key information is “category”, and the value information is [car]; {“subject”: B-model frame}, where the key information is “subject”, and the value information is [B-model frame]; and {“associated word”: mainstream frame of A car brand; the size is 4,750*1,921*1,624}, where the key information is “associated word”, and the value information is [mainstream frame of A car brand; the size is 4,750*1,921*1,624].

Semantic recognition is performed on the candidate segment [In the XX game event, discounted props include M, N, and Y] and the candidate segment [The props acquired at a discount in the XX game event are valid for one year]. The topic concept or related field involved in the candidate segment is games, and specifically, the game prop Y is involved. The game prop Y is a discounted prop in the XX game event and is valid for one year. Based on this, the following key-value pair used as [supplementary information unit c] is formed: {“category”: game}, where the key information is “category”, and the value information is [game]; {“subject”: game prop Y}, where the key information is “subject”, and the value information is [game prop Y]; and {“associated word”: M, N, props acquired at a discount in the XX game event, valid for one year}, where the key information is “association word”, and the value information is [M, N, props acquired at a discount in the XX game event, valid for one year].

Semantic recognition is performed on the candidate segment [Skins of the game character C include C1, C2, and C3] and the candidate segment [The game character C is referred to by players as: Great C, Great sage C, or Lord C]. The topic concept or related field involved in the candidate segment is games, and specifically, the game character C is involved. The game character C is further referred to by players as: Great C, Great sage C, or Lord C, and the skins of the game character C include C1, C2, and C3. Based on this, the following key-value pair used as [supplementary information unit d] is formed: {“category”: game}, where the key information is “category”, and the value information is [game]; {“subject”: game character C}, where the key information is “subject”, and the value information is [game character C]; and {“associated word”: C1, C2, C3, Great C, Great sage C, Lord C}, where the key information is “associated word”, and the value information is [C1, C2, C3, Great C, Great sage C, Lord C].

After the four key-value pairs, i.e., [supplementary information unit a], [supplementary information unit b], [supplementary information unit c], and [supplementary information unit d] are acquired, the four key-value pairs may be combined into a key-value pair set to form the information database.

### Detailed Description of Operation 340

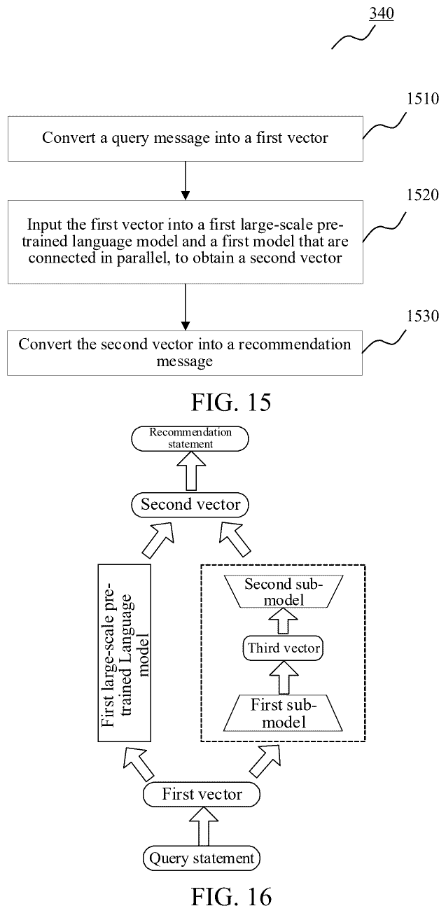

Referring to FIG. 15, operation 340 may include, but is not limited to, operation 1510 to operation 1530 described below.

Operation 1510: Convert the query message into a first vector.

Operation 1520: Input the first vector into the first large-scale pre-trained language model and a first model that are connected in parallel, to obtain a second vector.

Operation 1530: Convert the second vector into the recommendation message. The first vector and the second vector have a first dimension, and the first model includes a first sub-model and a second sub-model that are connected in series. The first sub-model is configured to convert the first vector into a third vector, the third vector has a second dimension smaller than the first dimension, and the second sub-model is configured to convert the third vector into the second vector. The first large-scale pre-trained language model and the first model are trained jointly, and only a weight matrix of the first model is adjusted during joint training.

Operation 1510 to operation 1530 are described in detail below.

In operation 1510, the query message is converted into the first vector. A process of converting the query message into the first vector may be referred to as text vectorization. The text vectorization is alternatively referred to as word embedding and refers to representing text information as a vector that can express text semantics, and represents text semantics using a value vector. There are various manners of text vectorization. For example, text vectorization, one-hot coding, bag-of-word (BOW) model, N-gram model (N-Gram), and the like are implemented through a neural network language model.

In operation 1520 to operation 1530, the first vector is inputted into the first large-scale pre-trained language model and the first model that are connected in parallel, to obtain the second vector, and then the second vector is converted into the recommendation message. The first vector and the second vector have a first dimension, and the first model includes a first sub-model and a second sub-model that are connected in series. The first sub-model is configured to convert the first vector into a third vector, the third vector has a second dimension smaller than the first dimension, and the second sub-model is configured to convert the third vector into the second vector. The first large-scale pre-trained language model and the first model are trained jointly, and only a weight matrix of the first model is adjusted during joint training. Converting the second vector into the recommendation message is a vector textualization process, the process and text vectorization are inverse processes of each other, and a processing process of vector textualization corresponds to a processing process of text vectorization.

Referring to FIG. 16, a principle is described for how the first large-scale pre-trained language model and the first model that are connected in parallel save resources:

There are generally two types of parameters in a machine learning model. One type needs to be obtained by learning and estimating data and is referred to as a model parameter, i.e., a learnable parameter of a model. For example, a weighting coefficient (slope) and a deviation term (intercept) of a linear regression straight line are model parameters. The learnable parameter is specifically a parameter value learned in a training process of the machine learning model. The learnable parameter usually starts from a group of random values, and then the values are iteratively updated as the machine learning model learns. In fact, when the artificial intelligence model learns, it more accurately means that parameters of the artificial intelligence model are being iteratively updated, and appropriate values of these parameters are gradually determined. The appropriate value may be a value that minimizes or converges a loss function. Another type is tuning parameters in machine learning algorithms. The tuning parameters need to be set flexibly according to existing experience and are alternatively referred to as hyperparameters. For example, a regularization coefficient λ is a depth of a tree in a decision tree model. The hyperparameter is also a parameter and has a characteristic of a parameter. For example, the hyperparameter is unknown, that is, the hyperparameter is not a known constant, but is a configurable value. A “correct” value, i.e., a flexibly set value, needs to be specified for the hyperparameter according to existing experience, and the value is not obtained by system learning.

The first large-scale pre-trained language model has a powerful language representation capability and can generate a recommendation message according to the first vector obtained after the text vectorization of the query message. However, the training and use process of the first large-scale pre-trained language model needs to occupy a lot of resources. To resolve the problem, in some embodiments of the present disclosure, a first model is connected in parallel to the first large-scale pre-trained language model, and the first model further includes a first sub-model and a second sub-model that are connected in series.

In some exemplary embodiments, the first vector needs to be first inputted into the first large-scale pre-trained language model and the first model that are connected in parallel. A dimension of the first vector is represented as d-dimension (i.e., the first dimension). If the first model and the first large-scale pre-trained language model are not connected in parallel, but the first large-scale pre-trained language model is directly configured to process the first vector to generate the recommendation message, the first large-scale pre-trained language model needs to directly process the d-dimension first vector. However, in a case that the first model and the first large-scale pre-trained language model are connected in parallel, a right “branch” in FIG. 16 is added, that is, the first sub-model needs to be adopted to perform dimension reduction on the d-dimension first vector to obtain an r-dimension (i.e., the second dimension) third vector. The dimension r of the third vector is a very important hyperparameter in the first model. The second sub-model is configured to increase the dimension of the third vector from the r-dimension to the d-dimension and output the third vector. In some embodiments, the dimension of the third vector may further be increased from the r-dimension to a dimension except the d-dimension. The output of the first model and the output of the left “branch” in FIG. 16, i.e., the first large-scale pre-trained language model, are added and fused to obtain the second vector.

In the process of jointly training the first large-scale pre-trained language model and the first model that are connected in parallel, under the effect of the right “branch” first model in FIG. 16, the number of parameters participating in the training changes from d*d to d*r+d*r. Since the dimension r of the third vector is smaller than the dimension d of the first vector, the number of parameters participating in the training is correspondingly reduced. The function of the first model in the joint training process is to replace the model parameter of the first large-scale pre-trained language model, and the first model is iteratively updated in joint training. In addition, in the use process of applying the first large-scale pre-trained language model and the first model that are connected in parallel to the generation of the recommendation message, under the effect of dimension reduction of the first model, computing resources occupied by the generation of the recommendation message can be reduced.

In embodiments of the present disclosure shown in operation 1510 to operation 1530, the first vector is processed using the first large-scale pre-trained language model and the first model that are connected in parallel, so that a lot of resources can be saved in the joint training process and the use process, thereby helping to more efficiently generate the recommendation message.

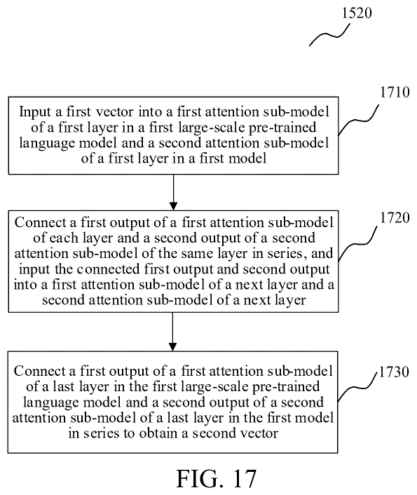

Referring to FIG. 17, the first large-scale pre-trained language model includes a plurality of layers of first attention sub-models connected in series, and the first model includes a plurality of layers of second attention sub-models connected in series. Operation 1520 may include, but is not limited to, operation 1710 to operation 1730 described below.

Operation 1710: Input the first vector into a first attention sub-model of a first layer in the first large-scale pre-trained language model and a second attention sub-model of a first layer in the first model.

Operation 1720: Connect a first output of a first attention sub-model of each layer and a second output of a second attention sub-model of the same layer in series, and input the connected first output and second output into a first attention sub-model of a next layer and a second attention sub-model of a next layer.

Operation 1730: Connect a first output of a first attention sub-model of a last layer in the first large-scale pre-trained language model and a second output of a second attention sub-model of a last layer in the first model in series to obtain the second vector.

Operation 1710 to operation 1730 are described in detail below.

In operation 1710 to operation 1730, the first vector is first inputted into the first attention sub-model of the first layer in the first large-scale pre-trained language model and the second attention sub-model of the first layer in the first model. In the processing process of the first vector, the first output of the first attention sub-model of each layer and the second output of the second attention sub-model of the same layer may be connected in series, and the connected first output and second output is inputted into the first attention sub-model of the next layer and the second attention sub-model of the next layer. Further, the first output of the first attention sub-model of the last layer in the first large-scale pre-trained language model and the second output of the second attention sub-model of the last layer in the first model are connected in series to obtain the second vector.

In the processing process of the first vector, the first output of the first attention sub-model of each layer and the second output of the second attention sub-model of the same layer may be connected in series, and the connected first output and second output is inputted into the first attention sub-model of the next layer and the second attention sub-model of the next layer, thereby helping to jointly train the first large-scale pre-trained language model and the first model that are connected in parallel. When the first large-scale pre-trained language model and the first model that are connected in parallel are jointly trained, a model parameter in the first large-scale pre-trained language model is frozen and not updated. The model parameter in the first model needs to be iteratively updated during joint training.

In some embodiments, to make the processing process of the first vector proceed layer by layer in the first large-scale pre-trained language model and the first model that are connected in parallel, the first output of the first attention sub-model of each layer and the second output of the second attention sub-model of the same layer need to be connected in series, and the connected first output and second output is inputted into the first attention sub-model of the next layer and the second attention sub-model of the next layer, until the processing process of the first vector flows to the last layer of the first large-scale pre-trained language model and the last layer of the first model. In this case, the first output of the first attention sub-model of the last layer in the first large-scale pre-trained language model and the second output of the second attention sub-model of the last layer in the first model are connected in series to obtain the second vector.

In this way, the function of the first model in the joint training process may be further optimized, that is, the first model replaces the model parameter of the first large-scale pre-trained language model and is iteratively updated in joint training. In addition, in the use process of applying the first large-scale pre-trained language model and the first model that are connected in parallel to the generation of the recommendation message, under the effect of dimension reduction of the first model, computing resources occupied by the generation of the recommendation message can be reduced.

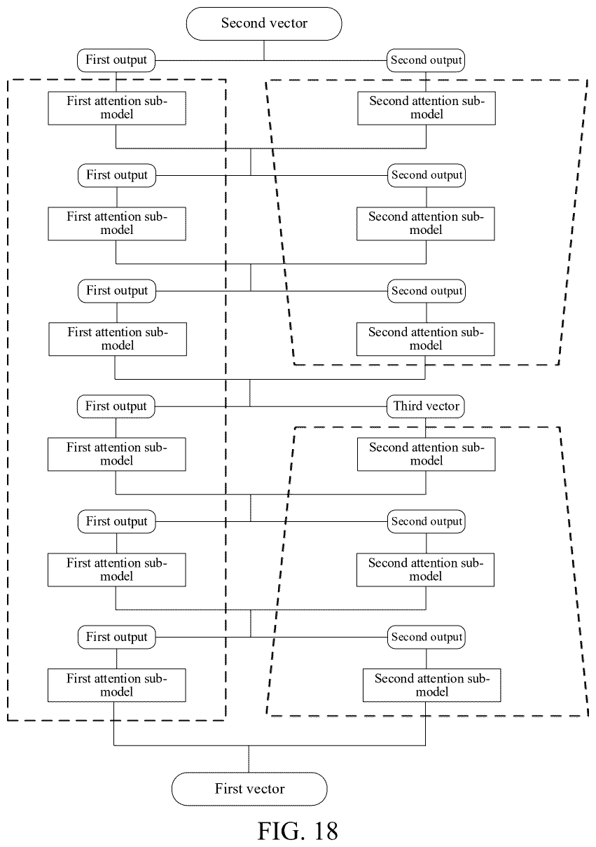

Referring to FIG. 18, the processing process of the first vector in operation 1710 to operation 1730 is described.

First, the first vector is inputted into the first attention sub-model of the first layer in the first large-scale pre-trained language model and the second attention sub-model of the first layer in the first model. Further, in the processing process of the first vector, the first output of the first attention sub-model of each layer and the second output of the second attention sub-model of the same layer are connected in series, and the connected first output and second output is inputted into the first attention sub-model of the next layer and the second attention sub-model of the next layer. The first model includes a first sub-model and a second sub-model that are connected in series. Each layer of the second attention sub-model in the first sub-model is configured to convert the first vector into a third vector, and the third vector has a second dimension smaller than the first dimension. An output of the second attention sub-model of the last layer in the first sub-model is the third vector. The second attention sub-model of each layer in the second sub-model is configured to convert the third vector into the second vector, and the second vector has a dimension higher than that of the third vector. The first large-scale pre-trained language model and the first model need to be jointly trained, and only the weight matrix of the first model is adjusted during the joint training. Still further, the first output of the first attention sub-model of the last layer in the first large-scale pre-trained language model and the second output of the second attention sub-model of the last layer in the first model are connected in series to obtain the second vector.

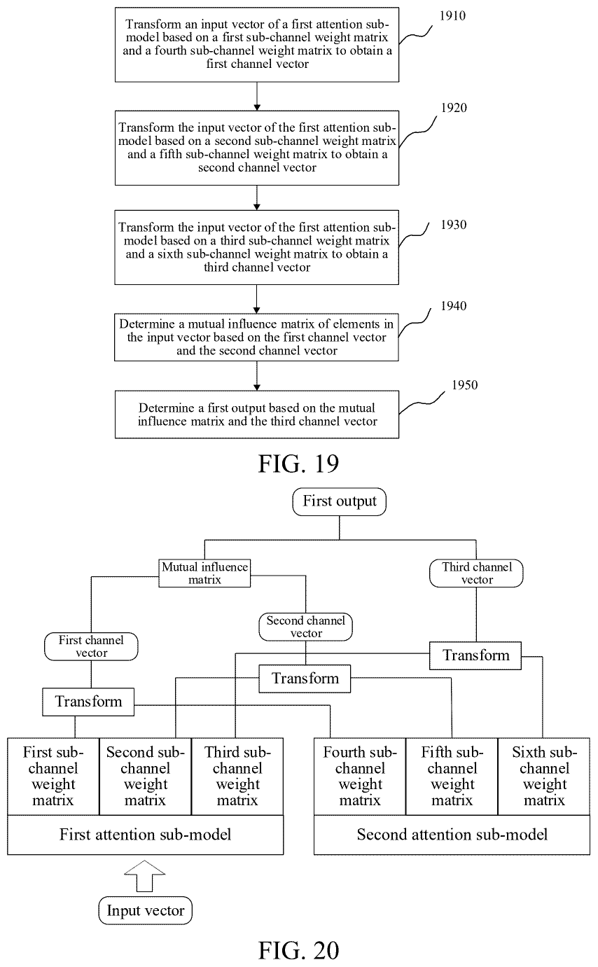

Referring to FIG. 19, in some embodiments of the present disclosure, the first attention sub-model has a first sub-channel weight matrix, a second sub-channel weight matrix, and a third sub-channel weight matrix, and the second attention sub-model in the same layer as the first attention sub-model has a fourth sub-channel weight matrix, a fifth sub-channel weight matrix, and a sixth sub-channel weight matrix. The first output is generated by the first attention sub-model, which may include, but is not limited to, operation 1910 to operation 1950 described below.

Operation 1910: Transform an input vector of the first attention sub-model based on the first sub-channel weight matrix and the fourth sub-channel weight matrix to obtain a first channel vector.

Operation 1920: Transform the input vector of the first attention sub-model based on the second sub-channel weight matrix and the fifth sub-channel weight matrix to obtain a second channel vector.

Operation 1930: Transform the input vector of the first attention sub-model based on the third sub-channel weight matrix and the sixth sub-channel weight matrix to obtain a third channel vector.

Operation 1940: Determine a mutual influence matrix of elements in the input vector based on the first channel vector and the second channel vector.

Operation 1950: Determine the first output based on the mutual influence matrix and the third channel vector.

Operation 1910 to operation 1950 are described in detail below.

In operation 1910 to operation 1950, the input vector of the first attention sub-model is transformed based on the first sub-channel weight matrix and the fourth sub-channel weight matrix to obtain the first channel vector. The input vector of the first attention sub-model is transformed based on the second sub-channel weight matrix and the fifth sub-channel weight matrix to obtain the second channel vector. The input vector of the first attention sub-model is transformed based on the third sub-channel weight matrix and the sixth sub-channel weight matrix to obtain the third channel vector. Further, the mutual influence matrix of elements in the input vector is determined based on the first channel vector and the second channel vector. Finally, the first output is determined based on the mutual influence matrix and the third channel vector.

Attention is an attention mechanism and may calculate correlation between each element and other elements in a sequence to obtain a new representation. Attention is a basic assembly of many modules. For example, a transformer model includes a plurality of attention sub-models, and a large-scale pre-trained language model includes a plurality of transformer models.

To describe a generation principle of the first output in this embodiment of the present disclosure, a processing principle of a general large-scale pre-trained language model needs to be described first.

In the general large-scale pre-trained language model, if an input of an attention sub-model is represented as an input vector X, the attention sub-model may adaptively scale elements of the input vector X according to a learning goal. The attention sub-model may be formally represented as:

$$Attention ( Q , K , V ) = softmax ( \frac{Q {K}^{T}}{\sqrt{{d}_{k}}} ) V$$

$$Q = {W}^{q} X$$

$$K = {W}^{k} X$$

$$V = {W}^{v} X ,$$

where Q, K, and V are learnable channel vectors, Q is the first channel vector, K is the second channel vector, and V is the third channel vector. Q is obtained by transforming the input vector X through a weight matrix W^{q}. K is obtained by transforming the input vector X through a weight matrix W^{k}. V is obtained by transforming the input vector X through a weight matrix W^{v}. The attention sub-model can capture global information and implement parallel computing.

The foregoing describes the processing principle of the general large-scale pre-trained language model. The generation principle of the first output in this embodiment of the present disclosure is described below, and the processing principle of the general large-scale pre-trained language model needs to be described first.

A schematic diagram of generating the first output is shown in FIG. 20. In this embodiment of the present disclosure, the first model is connected in parallel to the first large-scale pre-trained language model. The first large-scale pre-trained language model and the first model need to be jointly trained, and only the weight matrix of the first model is adjusted during the joint training. Therefore, this embodiment of the present disclosure needs to be distinguished from the general large-scale pre-trained language model. The first attention sub-model is formally represented as follows:

$$Q = {W}^{q} X = {W}_{plm}^{q} X + α {W}_{1}^{q} X$$

$$K = {W}^{k} X = {W}_{plm}^{k} X + α {W}_{1}^{k} X$$

$$V = {W}^{v} X = {W}_{plm}^{v} X + α {W}_{1}^{v} X$$

$$softmax ( Q , K ) = softmax ( {W}^{q} X * {W}^{k T} {X}^{T} )$$

$$Attention ( Q , K , V ) = softmax ( Q , K ) {W}^{v} X ,$$

where Q, K, and V are channel vectors when the first large-scale pre-trained language model and the first model are connected in parallel, Q is the first channel vector, K is the second channel vector, and V is the third channel vector. a is a weight coefficient, and softmax ( ) is a normalized exponential function.

The first channel vector Q is obtained by integrating and transforming the input vector X through a first sub-channel weight matrix

$${W}_{plm}^{q}$$

of the first attention sub-model and a fourth sub-channel weight matrix

$${{W}_{1}^{q}}_{ }$$

of the second attention sub-model.

The second channel vector K is obtained by integrating and transforming the input vector X through a second sub-channel weight matrix

$${W}_{plm}^{k}$$

of the first attention sub-model and a fifth sub-channel weight matrix

$${{W}_{1}^{k}}_{ }$$

of the second attention sub-model.

The third channel vector V is obtained by integrating and transforming the input vector X through a third sub-channel weight matrix

$${W}_{plm}^{v}$$

of the first attention sub-model and a sixth sub-channel weight matrix

$${W}_{1}^{v}$$

of the second attention sub-model.

After the first channel vector Q, the second channel vector K, and the third channel vector V are clarified, the mutual influence matrix softmax(Q, K) of the elements in the input vector may be determined based on the first channel vector Q and the second channel vector K, that is:

$$softmax ( Q , K ) = softmax ( {W}^{q} X * {W}^{k T} {X}^{T} ) .$$

Still further, a first output Attention(Q, K, V) is determined based on the mutual influence matrix softmax(Q K) and the third channel vector V, that is:

$$Attention ( Q , K , V ) = softma x ( Q , K ) {W}^{v} X .$$

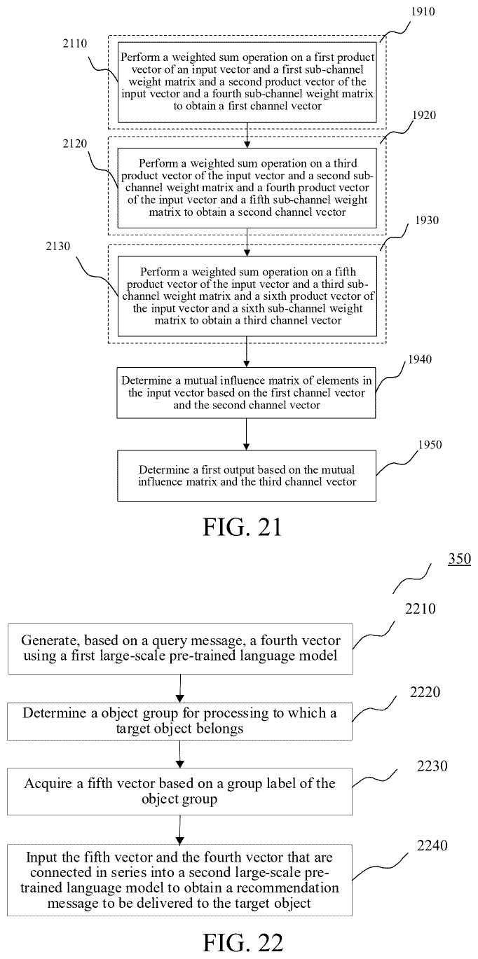

Referring to FIG. 21, operation 1910 may include, but is not limited to, operation 2110 described below.

Operation 2110: Perform a weighted sum operation on a first product vector of the input vector and the first sub-channel weight matrix and a second product vector of the input vector and the fourth sub-channel weight matrix to obtain the first channel vector.

Operation 1920 may include, but is not limited to, operation 2120 described below.

Operation 2120: Perform a weighted sum operation on a third product vector of the input vector and the second sub-channel weight matrix and a fourth product vector of the input vector and the fifth sub-channel weight matrix to obtain the second channel vector.

Operation 1930 may include, but is not limited to, operation 2130 described below.

Operation 2130: Perform a weighted sum operation on a fifth product vector of the input vector and the third sub-channel weight matrix and a sixth product vector of the input vector and the sixth sub-channel weight matrix to obtain the third channel vector.

Operation 2110 to operation 2130 are described in detail below.

In operation 2110, a weighted sum operation is performed on the first product vector of the input vector and the first sub-channel weight matrix and the second product vector of the input vector and the fourth sub-channel weight matrix to obtain the first channel vector.

The first channel vector Q is obtained by integrating and transforming the input vector X through the first sub-channel weight matrix

$${W}_{plm}^{q}$$

of the first attention sub-model and the fourth sub-channel weight matrix

$${W}_{1}^{q}$$

of the second attention sub-model. Specifically, a weighted sum operation may be performed on a first product vector

$${W}_{plm}^{q}$$

X of the input vector X and the first sub-channel weight matrix

$${W}_{plm}^{q}$$

and a second product vector

$${W}_{1}^{q} X$$

of the input vector X and the fourth sub-channel weight matrix

$${W}_{1}^{q}$$

according to the weight coefficient α to obtain the first channel vector, that is:

$$Q = {W}^{q} X = {W}_{plm}^{q} X + α {W}_{1}^{q} X .$$

In operation 2120, a weighted sum operation is performed on the third product vector of the input vector and the second sub-channel weight matrix and the fourth product vector of the input vector and the fifth sub-channel weight matrix to obtain the second channel vector.

The second channel vector K is obtained by integrating and transforming the model and the fifth sub-channel weight matrix

$${W}_{plm}^{k}$$

of the first attention sub-model and the fifth sub-channel weight matrix

$${W}_{1}^{k}$$

of the second attention sub-model. Specifically, a weighted sum operation may be performed on a third product vector

$${W}_{plm}^{k} X$$

of the input vector X and the second sub-channel weight matrix

$${W}_{plm}^{k}$$

and a fourth product vector

$${W}_{1}^{k} X$$

of the input vector x and the fifth sub-channel weight matrix

$${W}_{1}^{k}$$

according to the weight coefficient α to obtain the second channel vector, that is:

$$K = {W}^{k} X = {W}_{plm}^{k} X + α {W}_{1}^{k} X .$$

In operation 2130, a weighted sum operation is performed on the fifth product vector of the input vector and the third sub-channel weight matrix and the sixth product vector of the input vector and the sixth sub-channel weight matrix to obtain the third channel vector.

The third channel vector V is obtained by integrating and transforming the input vector X through the third sub-channel weight matrix

$${W}_{plm}^{v}$$

of the first attention sub-model and the sixth sub-channel weight matrix

$${W}_{1}^{v}$$

of the second attention sub-model. Specifically, a weighted sum operation may be performed on a fifth product vector

$${W}_{plm}^{v} X$$

of the input vector X and the third sub-channel weight matrix

$${W}_{plm}^{v}$$

and a sixth product vector

$${W}_{1}^{v} X$$

of the input vector X and the sixth sub-channel weight matrix

$${W}_{1}^{v}$$

according to the weight coefficient α to obtain the third channel vector, that is:

$$V = {W}^{v} X = {W}_{plm}^{v} X + α {W}_{1}^{v} X .$$

The foregoing describes the generation principle of the first output in this embodiment of the present disclosure. In embodiments of the present disclosure shown in 1910 to 1950, the first sub-channel weight matrix, the second sub-channel weight matrix, and the third sub-channel weight matrix in the first attention sub-model, and the fourth sub-channel weight matrix, the fifth sub-channel weight matrix, and the sixth sub-channel weight matrix in the second attention sub-model can be combined so that the first output fuses parameters in the first large-scale pre-trained language model and the first model. In this way, the function of the first model in the joint training process may be further optimized, that is, the first model replaces the model parameter of the first large-scale pre-trained language model and is iteratively updated in joint training. In addition, in the use process of applying the first large-scale pre-trained language model and the first model that are connected in parallel to the generation of the recommendation message, under the effect of dimension reduction of the first model, computing resources occupied by the generation of the recommendation message can be reduced.

### Detailed Description of Operation 350

Referring to FIG. 22, in some embodiments provided in the present disclosure, operation 350 may include, but is not limited to, operation 2210 to operation 2240 described below.

Operation 2210: Generate, based on the query message, a fourth vector using the first large-scale pre-trained language model.

Operation 2220: Determine a to-be-processed object group to which a target object belongs.

Operation 2230: Acquire a fifth vector based on a group label of the to-be-processed object group.

Operation 2240: Input the fifth vector and the fourth vector that are connected in series into a second large-scale pre-trained language model to obtain the recommendation message to be delivered to the target object.

Operation 2210 to operation 2240 are described in detail below.

The same recommendation message has different recommendation effects for different objects. For example, a recommendation message with a lively language style is popular among the young people, but not favored among the middle-aged and elderly people. Correspondingly, a serious and refined recommendation message is more popular among the middle-aged and elderly people. To generate, based on content having the same semantics, a plurality of recommendation messages with expression forms suitable for various groups, the present disclosure proposes embodiments shown in operation 2210 to operation 2240.

In operation 2210, based on the query message, the fourth vector is generated using the first large-scale pre-trained language model. The fourth vector of the first large-scale pre-trained language model is a semantic vector generated based on the query message and is configured for representing semantic content that satisfies a recommendation message generation requirement.

In operation 2220 to operation 2230, the to-be-processed object group to which the target object belongs is determined, and the fifth vector is acquired based on the group label of the to-be-processed object group. Before the recommendation message is generated, a target object to which the recommendation message needs to be delivered may be clarified first. Then, based on the to-be-processed object group to which the target object belongs, the group label of the to-be-processed object group is clarified so that the group to which the target object belongs may be determined. Therefore, the fifth vector may be acquired based on the group label of the to-be-processed object group. The fifth vector is configured for representing a group type to which the target object belongs.

In operation 2240, the fifth vector and the fourth vector that are connected in series are inputted into the second large-scale pre-trained language model to obtain the recommendation message to be delivered to the target object. Since the fourth vector is configured for representing semantic content that satisfies the recommendation message generation requirement, and the fifth vector is configured for representing a group type to which the target object belongs, after acquiring the fourth vector and the fifth vector, the second large-scale pre-trained language model may generate a corresponding recommendation message based on the semantic content of the recommendation message and the group type to which the target object belongs.

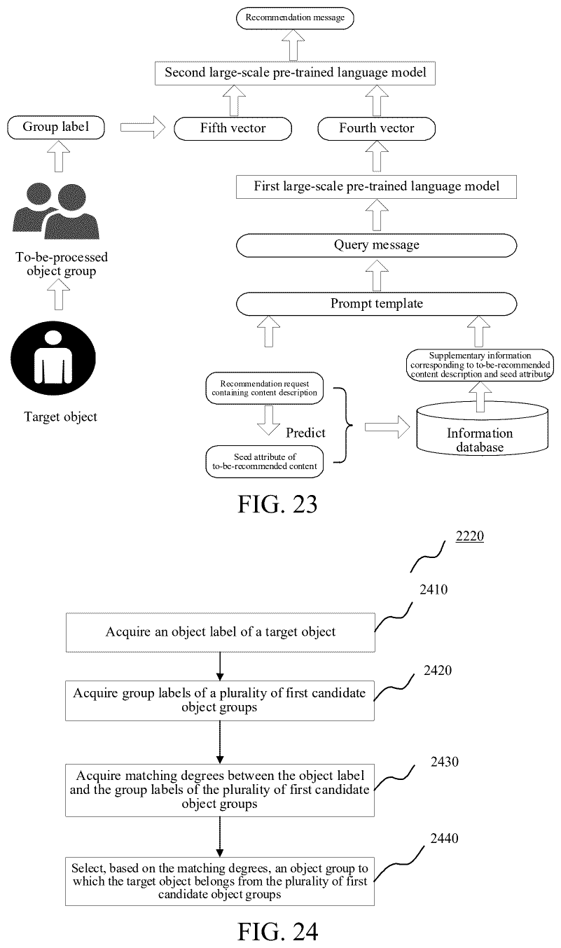

Referring to FIG. 23, in some specific embodiments provided in the present disclosure, the recommendation request containing the to-be-recommended content description needs to be acquired, and then the seed attribute of the to-be-recommended content is predicted based on the to-be-recommended content description. Further, based on the to-be-recommended content description and the seed attribute of the to-be-recommended content, the supplementary information corresponding to the to-be-recommended content description and the seed attribute is retrieved from the information database. Still further, the prompt template is populated with the to-be-recommended content description, and the supplementary information corresponding to the to-be-recommended content description and the seed attribute, and then the query message is obtained. Then, the query message is inputted into the first large-scale pre-trained language model, and the fourth vector configured for representing the semantic content that satisfies the recommendation message generation requirement is generated using a powerful semantic extraction capability of the first large-scale pre-trained language model. In addition, the object group to which the target object belongs needs to be determined, and then the fifth vector configured for representing the group type to which the target object belongs is acquired based on the group label of the object group. Finally, the fifth vector and the fourth vector that are connected in series are inputted into the second large-scale pre-trained language model to obtain, using a powerful text generation capability of the second large-scale pre-trained language model, the recommendation message corresponding to the target object.

In embodiments of the present disclosure shown in operation 2210 to operation 2240, recommendation messages suitable for the target object can be generated. These recommendation messages more easily attract clicking, viewing, and responding of the target object, which helps to improve the content conversion rate.

Referring to FIG. 24, according to some embodiments provided in the present disclosure, operation 2220 may include, but is not limited to, operation 2410 to operation 2440 described below.

Operation 2410: Acquire an object label of the target object.

Operation 2420: Acquire group labels of a plurality of first candidate object groups.

Operation 2430: Acquire matching degrees between the object label and the group labels of the plurality of first candidate object groups.

Operation 2440: Select, based on the matching degrees, the to-be-processed object group to which the target object belongs from the plurality of first candidate object groups. Operation 2410 to operation 2440 are described in detail below.

In operation 2410, the object label of the target object is acquired. The object label of the target object is configured for identifying a feature attribute of the target object, and the feature attribute corresponds to a knowledge field.

In operation 2420, the group labels of the plurality of first candidate object groups are acquired. The group label of the first candidate object group is configured for identifying a common feature attribute of member objects in the first candidate object group, and the common feature attribute corresponds to a knowledge field.

In operation 2430, the matching degrees between the object label and the group labels of the plurality of first candidate object groups are acquired. After the object label of the target object and the group labels of the plurality of first candidate object groups are acquired, the matching degrees between the object label and the group labels of the plurality of first candidate object groups are calculated to determine which first candidate object group the target object specifically belongs to.

In operation 2440, based on the matching degrees, the to-be-processed object group to which the target object belongs is selected from the plurality of first candidate object groups. After the matching degrees between the object label and the group label of the first candidate object groups are clarified, the to-be-processed object group to which the target object belongs may be clarified according to the matching degrees. The target object may belong to a single first candidate object group, or may belong to a plurality of first candidate object groups.

In some specific embodiments, the target object may have a plurality of object labels, for example, “game player”, “music enthusiast”, and “movie fan”. Therefore, when the matching degrees between the object label and the group label of the plurality of first candidate object groups are acquired, first candidate object groups such as a “game player” first candidate object group, a “music enthusiast” first candidate object group, and a “movie fan” first candidate object group each have a high matching degree. In this case, a matching degree threshold may be set. When a matching degree between the object label and a group label of a first candidate object group is higher than the matching degree threshold, the first candidate object group is determined as the to-be-processed object group to which the target object belongs. In some other embodiments, the first candidate object groups may be sorted in descending order of matching degrees, and then the first several first candidate object groups are determined as the to-be-processed object groups to which the target object belongs.

There are various implementations of determining the to-be-processed object group to which the target object belongs. The implementations may include, but are not limited to, the foregoing specific embodiments.

In embodiments of the present disclosure shown in operation 2410 to operation 2440, the to-be-processed object group to which the target object belongs is determined so that recommendation messages suitable for the target object can be generated. These recommendation messages more easily attract clicking, viewing, and responding of the target object, which helps to improve the content conversion rate.

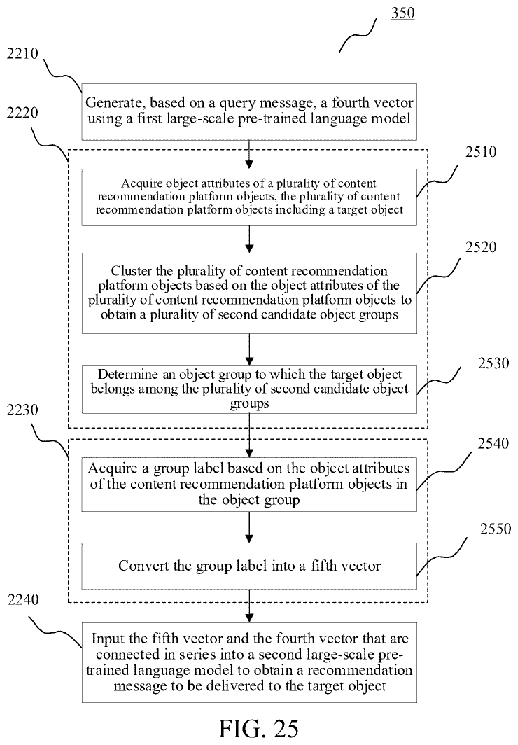

Referring to FIG. 25, in some embodiments provided in the present disclosure, operation 2220 may include, but is not limited to, operation 2510 to operation 2530 described below.

Operation S2510: Acquire object attributes of a plurality of content recommendation platform objects, the plurality of content recommendation platform objects including the target object.

Operation 2520: Cluster the plurality of content recommendation platform objects based on the object attributes of the plurality of content recommendation platform objects to obtain a plurality of second candidate object groups.

Operation 2530: Determine the to-be-processed object group to which the target object belongs among the plurality of second candidate object groups.

2230 may include, but is not limited to, operation 2540 to operation 2550 described below.

Operation 2540: Acquire the group label based on the object attributes of the content recommendation platform objects in the to-be-processed object group.

Operation S2550: Convert the group label into the fifth vector.

Operation 2510 to operation 2550 are described in detail below.

In operation 2510 to operation 2530, the object attributes of the plurality of content recommendation platform objects are first acquired, and the plurality of content recommendation platform objects include the target object. Then, the plurality of content recommendation platform objects are clustered based on the object attributes of the plurality of content recommendation platform objects to obtain the plurality of second candidate object groups. Later, the to-be-processed object group to which the target object belongs is determined among the plurality of second candidate object groups. The content recommendation platform refers to an Internet platform configured to recommend content on the Internet, and may alternatively be considered as an Internet platform on which various recommendation messages are delivered. An object clicking and viewing various recommendation messages on the content recommendation platform is the content recommendation platform object. After the object attributes of the plurality of content recommendation platform objects are acquired, the plurality of content recommendation platform objects are clustered based on the object attributes of the plurality of content recommendation platform objects to obtain the plurality of second candidate object groups. Still further, the target object is found from the plurality of second candidate object groups so that the to-be-processed object group to which the target object belongs may be determined among the plurality of second candidate object groups.

Clustering refers to dividing a data set into different categories or clusters according to a particular criterion (for example, a distance) so that the similarity of data objects in the same cluster is as large as possible, and the difference of data objects that are not in the same cluster is as large as possible. That is, after clustering, data of the same category are gathered together as much as possible, and data of different categories are separated as much as possible. Data clustering methods may be mainly classified into partition-based clustering methods, density-based clustering methods, hierarchical clustering methods, and the like.

In operation 2540 to operation 2550, the group label is acquired based on the object attributes of the content recommendation platform objects in the to-be-processed object group and converted into the fifth vector. The group labels of the second candidate object groups cannot be directly acquired through the plurality of second candidate object groups obtained by clustering the plurality of content recommendation platform objects. Since the plurality of second candidate object groups are generated by clustering based on the object attributes of the plurality of content recommendation platform objects, the group label can be obtained according to the object attributes of the content recommendation platform objects. After the group label is acquired, the group label may be further converted into the fifth vector configured for representing the group type to which the target object belongs.

In embodiments of the present disclosure shown in operation 2510 to operation 2550, the to-be-processed object group to which the target object belongs is determined so that recommendation messages suitable for the target object can be generated. These recommendation messages more easily attract clicking, viewing, and responding of the target object, which helps to improve the content conversion rate.

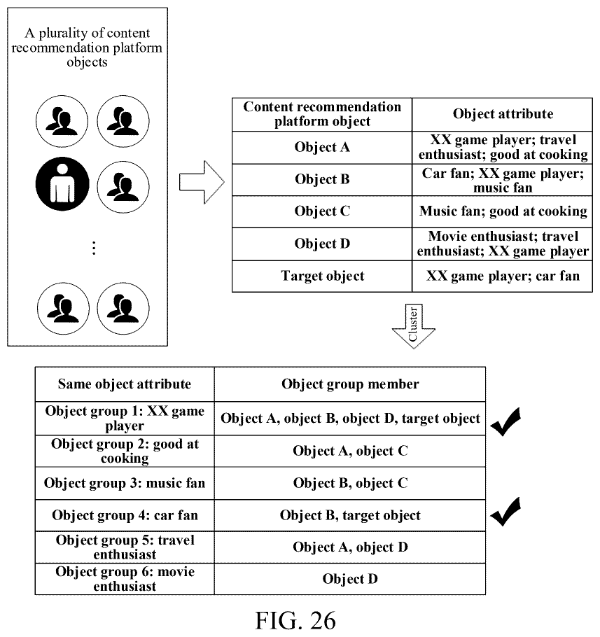

Referring to FIG. 26, an exemplary diagram of generating a plurality of second candidate object groups, determining the to-be-processed object group to which the target object belongs among the plurality of second candidate object groups, and acquiring the group label based on the object attributes of the content recommendation platform objects in the to-be-processed object group is shown.

First, the object attributes of the plurality of content recommendation platform objects need to be acquired, and the plurality of content recommendation platform objects include the target object. An object attribute of an object A is “XX game player; travel enthusiast; good at cooking”. An object attribute of an object B is “car fan; XX game player; music fan”. An object attribute of an object C is “music fan; good at cooking”. An object attribute of an object D is “movie enthusiast; travel enthusiast; XX game player”. An object attribute of the target object is “XX game player; travel enthusiast; good at cooking”.

The plurality of content recommendation platform objects are clustered based on the object attributes of the plurality of content recommendation platform objects to obtain the plurality of second candidate object groups. The plurality of second candidate object groups are an object group 1, an object group 2, an object group 3, an object group 4, an object group 5, and an object group 6. The object group 1 includes: the object A, the object B, the object D, and the target object. The object group 2 includes: the object A and the object C. The object group 3 includes: the object B and the object C. The object group 4 includes: the object B and the target object. The object group 5 includes: the object A and the object D. The content object group 6 includes: the object D.

By examining member objects of the second candidate object groups, it may be clarified that in the foregoing six second candidate object groups, only the second candidate object group 1 and the second candidate object group 4 each include the target object. Therefore, the to-be-processed object groups to which the target object belongs are the second candidate object group 1 and the second candidate object group 4.

The second candidate object group 1 to which the target object belongs is formed by clustering the common object attribute “XX game player” of the member objects. Therefore, the group label of the second candidate object group 1 is determined as “XX game player” based on the object attributes of the content recommendation platform objects in the object group 1.

The second candidate object group 4 to which the target object belongs is formed by clustering the common object attribute “car fan” of the member objects. Therefore, the group label of the second candidate object group 4 is determined as “car fan” based on the object attribute of the content recommendation platform objects in the second candidate object group 4.

There are multiple implementations of acquiring the group label of the to-be-processed object group to which the target object belongs. This is not limited to the foregoing examples.

In some specific embodiments of the present disclosure, acquiring the group label based on the object attributes of the content recommendation platform objects in the to-be-processed object group of operation 2540 may specifically include, but is not limited to:
determining the number of occurrence times of each object attribute in the plurality of content recommendation platform objects of the to-be-processed object group; and
determining the group label based on the number of occurrence times.

When one object group includes a plurality of objects, and each object has a plurality of object attributes, for each object attribute involved in the object group, the number of objects within the object group that possess this object attribute is counted, that is, the number of occurrence times of the object attribute in the plurality of content recommendation platform objects of the object group is determined. Then, the group label is determined based on the number of occurrence times of the object attribute. In some embodiments, if the number of occurrence times of an object attribute is the largest, the object attribute may be determined as the group label.

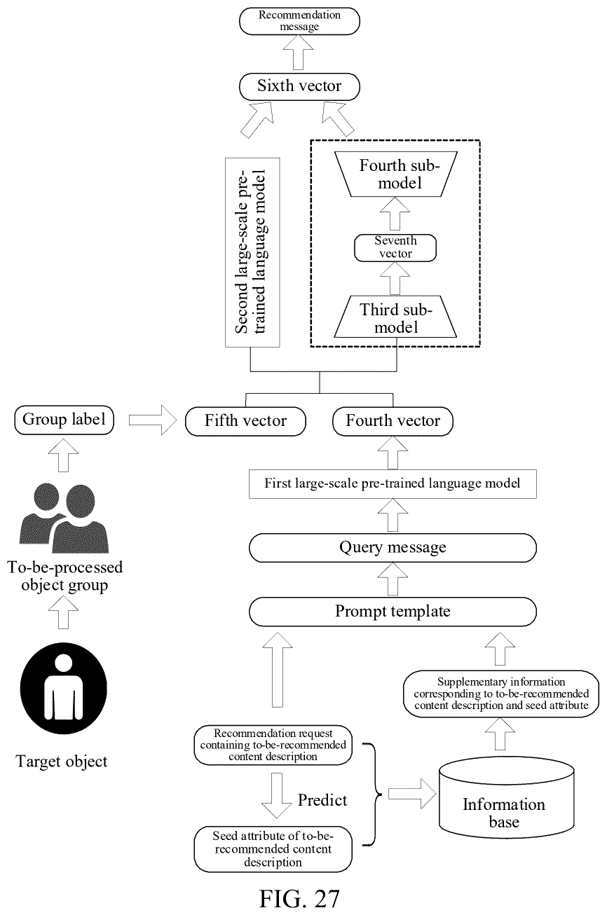

Referring to FIG. 27, some specific embodiments of the present disclosure are shown. Operation 2240 may include:
inputting the fifth vector and the fourth vector that are connected in series into the second large-scale pre-trained language model and a second model that are connected in parallel, to obtain a sixth vector, and converting the sixth vector into the recommendation message to be delivered to the target object, where the fifth vector and the fourth vector that are connected in series have a third dimension, and the sixth vector further has the third dimension; the second model includes a third sub-model and a fourth sub-model that are connected in series; the third sub-model is configured to convert the fifth vector and the fourth vector that are connected in series into a seventh vector, the seventh vector has a fourth dimension smaller than the third dimension, and the fourth sub-model is configured to convert the seventh vector into the sixth vector; and the second large-scale pre-trained language model and the second model are trained jointly, and only a weight matrix of the second model is adjusted during joint training.

The second large-scale pre-trained language model has a powerful language representation capability and can generate the recommendation message according to the fourth vector and the fifth vector that are connected in series. However, the training and use process of the second large-scale pre-trained language model needs to occupy a lot of resources. To resolve the problem, in some embodiments of the present disclosure, a second model is connected in parallel to the second large-scale pre-trained language model, and the second model further includes a third sub-model and a fourth sub-model that are connected in series.

In some exemplary embodiments, the fourth vector and the fifth vector that are connected in series need to be first inputted into the second large-scale pre-trained language model and the second model that are connected in parallel. Dimensions of the fourth vector and the fifth vector that are connected in series are represented as d-dimension. If the second model and the second large-scale pre-trained language model are not connected in parallel, but the second large-scale pre-trained language model is directly configured to process the fourth vector and the fifth vector that are connected in series, to generate the recommendation message, the second large-scale pre-trained language model needs to directly process the d-dimension fourth vector and the d-dimension fifth vector that are connected in series. However, in a case that the second model and the second large-scale pre-trained language model are connected in parallel, a right “branch” in FIG. 27 is added, that is, the third sub-model needs to be adopted to perform dimension reduction on the d-dimension fourth vector and the d-dimension fifth vector that are connected in series, to obtain an r-dimension seventh vector. The dimension r of the seventh vector is a very important hyperparameter in the second model. The fourth sub-model is configured to increase the dimension of the seventh vector from the r-dimension to the d-dimension and output the seventh vector. In some embodiments, the dimension of the seventh vector may further be increased from the r-dimension to a dimension except the d-dimension. The output of the second model and the output of the left “branch” in FIG. 27, i.e., the second large-scale pre-trained language model, are added and fused to obtain the sixth vector.

In the process of jointly training the second large-scale pre-trained language model and the second model that are connected in parallel, under the effect of the right “branch” second model in FIG. 27, the number of parameters participating in the training changes from d*d to d*r+d*r. Since the dimension r of the seventh vector is smaller than the dimension d of the fourth vector and the fifth vector that are connected in series, the number of parameters participating in the training is correspondingly reduced. The function of the second model in the joint training process is to replace the model parameter of the second large-scale pre-trained language model, and the second model is iteratively updated in joint training. In addition, in the use process of applying the second large-scale pre-trained language model and the second model that are connected in parallel to the generation of the recommendation message, under the effect of dimension reduction of the second model, computing resources occupied by the generation of the recommendation message can be reduced.

According to an embodiment of the present disclosure shown in FIG. 27, the fourth vector and the fifth vector that are connected in series are processed using the second large-scale pre-trained language model and the second model that are connected in parallel, so that a lot of resources can be saved in the joint training process and the use process, thereby helping to more efficiently generate the recommendation message corresponding to the group label.

### Summary Presentation of Specific Embodiment of the Present Disclosure

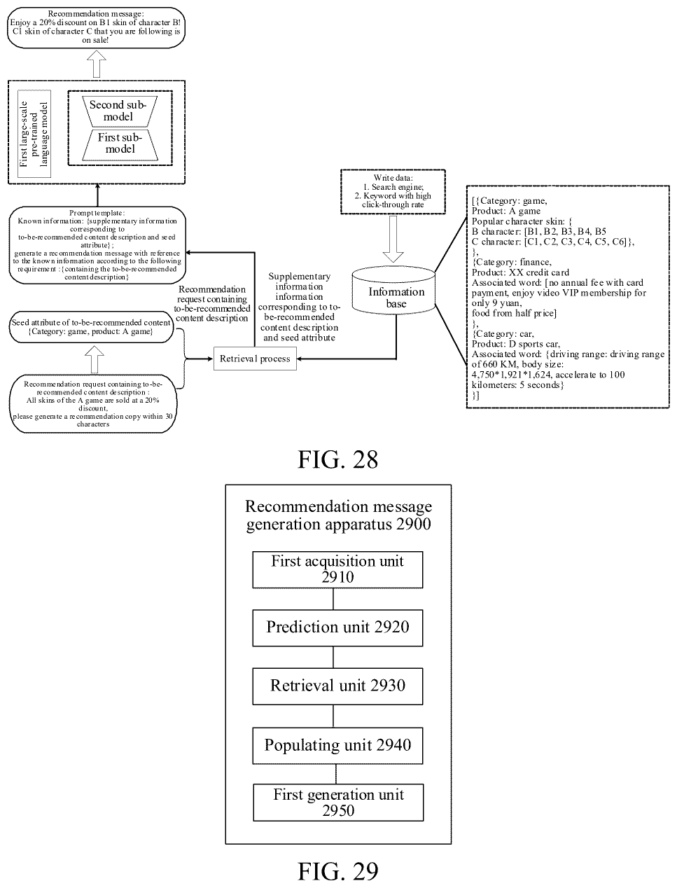

Referring to FIG. 28, an exemplary embodiment of the generation of a recommendation message is shown.

First, a recommendation request containing a to-be-recommended content description: “All skins of the A game are sold at a 20% discount, please generate a recommendation copy within 30 characters” is acquired. Further, a seed attribute {‘category’: game, ‘product’: A game} of the to-be-recommended content is predicted based on the foregoing to-be-recommended content description.

After the seed attribute of the to-be-recommended content is acquired, information retrieval is performed in an information database based on the to-be-recommended content description and the seed attribute to obtain supplementary information corresponding to the to-be-recommended content description and the seed attribute. The information database includes search engines and keywords with high click-through rates. Data written to the supplementary information data is stored in the form of key-value pairs. For example:

```
  [{
  “Category”: “game”,
  “Product”: “A game”,
  “Popular character skin”: {
    “B character”: [“B1”, “B2”, “B3”, “B4”, “B5”],
    “C character”: [“C1”, “C2”, “C3”, “C4”, “C5”, “C6”]},
  },
  {
  “Category”: “finance”,
  “Product”: “XX credit card”,
  “Associated word”: [“no annual fee with card payment”, “enjoy video
VIP membership for only 9 yuan”, “food from half price”]
  },
  ......
  {
  “Category”: “car”,
  “Product”: “D sports car”,
  “Associated word”: {“driving range”: “driving range of 660 KM”,
“body size”: “4,750*1,921*1,624”, “accelerate to 100 kilometers”: “5
seconds”}
  }].
```

Still further, after the supplementary information corresponding to the to-be-recommended content description and the seed attribute is obtained, the prompt template is populated with the to-be-recommended content description and the supplementary information to obtain the query message. The prompt template is: “known information: {supplementary information corresponding to to-be-recommended content description and seed attribute}; generate a recommendation message with reference to the known information according to the following requirement: {recommendation request containing to-be-recommended content description}”. The {supplementary information corresponding to to-be-recommended content description and seed attribute} in the prompt template is configured for filling in the supplementary information retrieved from the information database in the foregoing operation. {containing the to-be-recommended content description} is configured for filling in the to-be-recommended content description.

Further, the query message is inputted into the first large-scale pre-trained language model and the first model that are connected in parallel, and the recommendation message is generated using a powerful language representation capability of the first large-scale pre-trained language model. In addition, a lot of resources may be saved in the joint training process and the use process, thereby helping to more efficiently generate the recommendation message.

### Descriptions of Apparatus and Device in Embodiments of the Present Disclosure

Although the various operations in the foregoing flowcharts are shown sequentially as indicated by the arrows, these operations are not necessarily performed sequentially in the order indicated by the arrows. Unless otherwise explicitly specified in the embodiments, execution of the operations is not strictly limited, and the operations may be performed in other orders. Moreover, at least some of the steps in the foregoing flowcharts may include a plurality of steps or a plurality of stages. These steps or stages are not necessarily performed at the same time, but may be performed at different times. Execution of these steps or stages is not necessarily sequentially performed, but may be performed in turn or alternately with other steps or at least some of steps or stages of other steps.

In specific embodiments of the present disclosure, when related processing needs to be performed according to data related to a property of a target object, such as attribute information or an attribute information set of the target object, permission or consent of the target object is first obtained, and acquisition, usage, processing, and the like of the data comply with related laws, regulations, and standards. In addition, when the attribute information of the target object needs to be obtained in the embodiments of the present disclosure, individual permission or individual consent of the target object is obtained through a pop-up window or jumping to a confirmation page. After the individual permission or the individual consent of the target object is explicitly obtained, necessary target object-related data for enabling the embodiments of the present disclosure to operate normally is obtained.

According to an aspect of the present disclosure, a recommendation message generation apparatus 2900 for content recommendation is provided, including:
a first acquisition unit 2910 configured to acquire a recommendation request of to-be-recommended content, the recommendation request containing a to-be-recommended content description;
a prediction unit 2920 configured to predict a seed attribute of the to-be-recommended content based on the to-be-recommended content description;
a retrieval unit 2930 configured to perform information retrieval in an information database based on the to-be-recommended content description and the seed attribute to obtain supplementary information corresponding to the to-be-recommended content description and the seed attribute;
a populating unit 2940 configured to populate a prompt template with the to-be-recommended content description and the supplementary information to obtain a query message; and
a first generation unit 2950 configured to generate, based on the query message, a recommendation message of the to-be-recommended content using a first large-scale pre-trained language model.

In one embodiment, the first generation unit 2950 is specifically configured to:
convert the query message into a first vector;
input the first vector into the first large-scale pre-trained language model and a first model that are connected in parallel, to obtain a second vector; and
convert the second vector into the recommendation message.

The first vector and the second vector have a first dimension, and the first model includes a first sub-model and a second sub-model that are connected in series; the first sub-model is configured to convert the first vector into a third vector, the third vector has a second dimension smaller than the first dimension, and the second sub-model is configured to convert the third vector into the second vector; and the first large-scale pre-trained language model and the first model are trained jointly, and only a weight matrix of the first model is adjusted during joint training.

In one embodiment, the first large-scale pre-trained language model includes a plurality of layers of first attention sub-models connected in series, and the first model includes a plurality of layers of second attention sub-models connected in series.

The first generation unit 2950 is specifically configured to:
input the first vector into a first attention sub-model of a first layer in the first large-scale pre-trained language model and a second attention sub-model of a first layer in the first model;
connect a first output of a first attention sub-model of each layer and a second output of a second attention sub-model of the same layer in series, and input the connected first output and second output into a first attention sub-model of a next layer and a second attention sub-model of a next layer; and
connect a first output of a first attention sub-model of a last layer in the first large-scale pre-trained language model and a second output of a second attention sub-model of a last layer in the first model in series to obtain the second vector.

In one embodiment, the first attention sub-model has a first sub-channel weight matrix, a second sub-channel weight matrix, and a third sub-channel weight matrix, and the second attention sub-model in the same layer as the first attention sub-model has a fourth sub-channel weight matrix, a fifth sub-channel weight matrix, and a sixth sub-channel weight matrix.

The first generation unit 2950 is specifically configured to obtain the first output, and the first output is generated by the first attention sub-model in the following manner:
transforming an input vector of the first attention sub-model based on the first sub-channel weight matrix and the fourth sub-channel weight matrix to obtain a first channel vector;
transforming the input vector of the first attention sub-model based on the second sub-channel weight matrix and the fifth sub-channel weight matrix to obtain a second channel vector;
transforming the input vector of the first attention sub-model based on the third sub-channel weight matrix and the sixth sub-channel weight matrix to obtain a third channel vector;
determining a mutual influence matrix of elements in the input vector based on the first channel vector and the second channel vector; and
determining the first output based on the mutual influence matrix and the third channel vector.

In one embodiment, the first generation unit 2950 is specifically configured to:
perform a weighted sum operation on a first product vector of the input vector and the first sub-channel weight matrix and a second product vector of the input vector and the fourth sub-channel weight matrix to obtain the first channel vector;
perform a weighted sum operation on a third product vector of the input vector and the second sub-channel weight matrix and a fourth product vector of the input vector and the fifth sub-channel weight matrix to obtain the second channel vector; and
perform a weighted sum operation on a fifth product vector of the input vector and the third sub-channel weight matrix and a sixth product vector of the input vector and the sixth sub-channel weight matrix to obtain the third channel vector.

In one embodiment, the seed attribute includes a to-be-recommended content subject and a to-be-recommended content type.

The prediction unit 2920 is specifically configured to:
input the to-be-recommended content description into a subject prediction model to obtain a predicted to-be-recommended content subject; and
input the to-be-recommended content description into a type prediction model to obtain a predicted to-be-recommended content type.

In one embodiment, the information database includes a plurality of supplementary information units.

The retrieval unit 2930 is specifically configured to:
use the seed attribute as a keyword, and screen supplementary information units containing keywords from the plurality of supplementary information units as screened supplementary information units; and
acquire, from the screened supplementary information units, screened supplementary information units matching the to-be-recommended content description, and integrate the screened supplementary information units into the supplementary information corresponding to the to-be-recommended content description and the seed attribute.

In one embodiment, the retrieval unit 2930 is specifically configured to:
generate a first semantic vector based on the to-be-recommended content description;
generate second semantic vectors based on the screened supplementary information units;
determine similarities between the first semantic vector and the second semantic vectors corresponding to the screened supplementary information units; and
determine, based on the similarities, the screened supplementary information units matching the to-be-recommended content description.

In one embodiment, the recommendation message generation apparatus 2900 for content recommendation further includes an information database generation unit (not shown), configured to generate the information database.

The information database generation unit is specifically configured to:
acquire a recommendation message browsing record of a content recommendation platform object;
acquire seed words based on the recommendation message browsing record;
perform corpus retrieval using the seed words to obtain candidate segments containing the seed words; and
generate the supplementary information units based on the candidate segments to form the information database.

In one embodiment, the information database generation unit is specifically configured to:
acquire, based on the recommendation message browsing record, the number of opening times that a link corresponding to each historical recommendation message is opened by the content recommendation platform object;
determine a seed recommendation message in the historical recommendation message based on the number of opening times; and
perform keyword extraction on the seed recommendation message to obtain the seed word.

In one embodiment, the supplementary information unit is a key-value pair set.

The information database generation unit is specifically configured to:
perform semantic recognition on the candidate segment to obtain a semantic recognition result; and
acquire, based on the semantic recognition result, a plurality of key-value pairs from the candidate segment to form the key-value pair set.

In one embodiment, the first generation unit 2950 is specifically configured to:
generate, based on the query message, a fourth vector using the first large-scale pre-trained language model;
determine a to-be-processed object group to which a target object belongs;
acquire a fifth vector based on a group label of the to-be-processed object group; and
input the fifth vector and the fourth vector that are connected in series into a second large-scale pre-trained language model to obtain the recommendation message to be delivered to the target object.

In one embodiment, the first generation unit 2950 is specifically configured to:
input the fifth vector and the fourth vector that are connected in series into the second large-scale pre-trained language model and a second model that are connected in parallel, to obtain a sixth vector, and convert the sixth vector into the recommendation message to be delivered to the target object.

The fifth vector and the fourth vector that are connected in series have a third dimension, and the sixth vector further has the third dimension; the second model includes a third sub-model and a fourth sub-model that are connected in series; the third sub-model is configured to convert the fifth vector and the fourth vector that are connected in series into a seventh vector, the seventh vector has a fourth dimension smaller than the third dimension, and the fourth sub-model is configured to convert the seventh vector into the sixth vector; and the second large-scale pre-trained language model and the second model are trained jointly, and only a weight matrix of the second model is adjusted during joint training.

In one embodiment, the first generation unit 2950 is specifically configured to:
acquire an object label of the target object;
acquire group labels of a plurality of first candidate object groups;
acquire matching degrees between the object label and the group labels of the plurality of first candidate object groups; and
select, based on the matching degrees, the to-be-processed object group to which the target object belongs from the plurality of first candidate object groups.

In one embodiment, the first generation unit 2950 is specifically configured to:
acquire object attributes of a plurality of content recommendation platform objects, the plurality of content recommendation platform objects including the target object;
cluster the plurality of content recommendation platform objects based on the object attributes of the plurality of content recommendation platform objects to obtain a plurality of second candidate object groups;
determine the to-be-processed object group to which the target object belongs among the plurality of second candidate object groups;
acquire the group label based on the object attributes of the content recommendation platform objects in the to-be-processed object group; and
convert the group label into the fifth vector.

In one embodiment, the first generation unit 2950 is specifically configured to:
determine the number of occurrence times of each object attribute in the plurality of content recommendation platform objects of the to-be-processed object group; and
determine the group label based on the number of occurrence times.

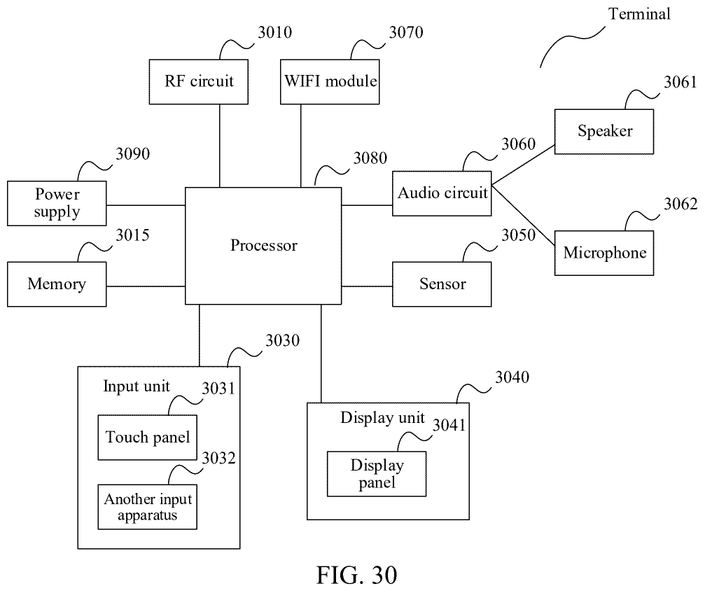

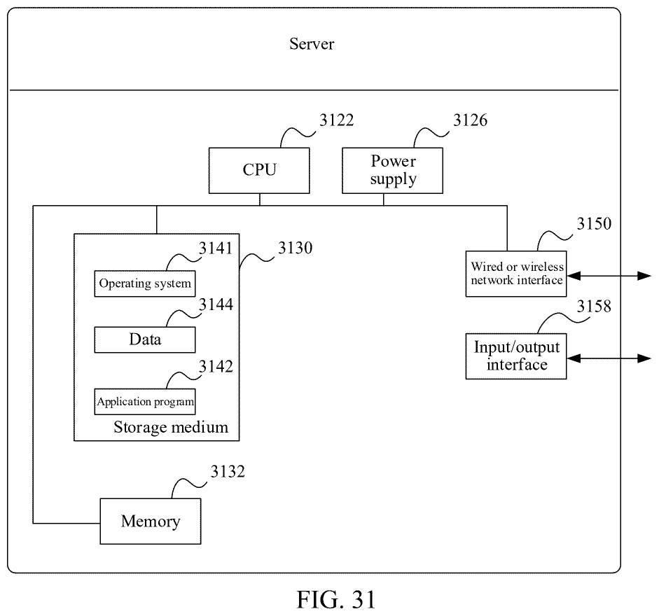

FIG. 30 is a structural block diagram of a part of a terminal 140 that implements the recommendation message generation method for content recommendation according to an embodiment of the present disclosure. The terminal includes: components such as a radio frequency (RF) circuit 3010, a memory 3015, an input unit 3030, a display unit 3040, a sensor 3050, an audio circuit 3060, a wireless fidelity (Wi-Fi) module 3070, a processor 3080, and a power supply 3090. A person skilled in the art may understand that the terminal structure shown in FIG. 30 does not constitute a limitation on a mobile phone or a computer, and the mobile phone or the computer may include more or fewer components than those shown in the figure, or a combination of some components, or have a different arrangement of components.

The RF circuit 3010 may be configured to receive and transmit signals during an information receiving and transmitting process or a call process. Specifically, the RF circuit 3010 receives downlink information from a base station, and then delivers the downlink information to the processor 3080 for processing. In addition, related uplink data is transmitted to the base station.

The memory 3015 may be configured to store software programs and modules, and the processor 3080 executes various functional applications and data processing of the terminal by running the software programs and the modules stored in the memory 3015.

The input unit 3030 may be configured to receive inputted digit or character information and generate a key signal input related to settings and function control of the terminal. Specifically, the input unit 3030 may include a touch panel 3031 and another input apparatus 3032.

The display unit 3040 may be configured to display inputted information or provided information, and various menus of the terminal. The display unit 3040 may include a display panel 3041.

The audio circuit 3060, a speaker 3061, and a microphone 3062 may provide audio interfaces.

In this embodiment, the processor 3080 included in the terminal may perform the recommendation message generation method for content recommendation in the foregoing embodiments.

The terminal in the embodiments of the present disclosure includes, but is not limited to, a mobile phone, a computer, an intelligent voice interaction device, an intelligent household appliance, an in-vehicle terminal, an aircraft, and the like. The embodiments of the present disclosure may be applied to various scenes, including but not limited to, artificial intelligence, big data, data processing, and the like.

FIG. 31 is a structural block diagram of a part of a server that implements the recommendation message generation method for content recommendation according to an embodiment of the present disclosure. A server 110 may vary greatly due to different configurations or performance, and may include one or more central processing units (CPUs) 3122 (for example, one or more processors), a memory 3132, and one or more storage media 3130 (for example, one or more mass storage apparatuses) that store an application program 3142 or data 3144. The memory 3132 and the storage medium 3130 may be transient storage or persistent storage. A program stored in the storage medium 3130 may include one or more modules (not marked in the figure), and each module may include a series of instruction operations on the server 3100. Further, the CPU 3122 may be configured to communicate with the storage medium 3130 and perform, on the server 3100, the series of instruction operations on the storage medium 3130.

The server 3100 may further include one or more power supplies 3126, one or more wired or wireless network interfaces 3150, one or more input/output interfaces 3158, and/or one or more operating systems 3141, such as Windows Server™, Mac OS X™, Unix™, Linux™, and FreeBSD™.

The processor in the server 3100 may be configured to perform the recommendation message generation method for content recommendation in the embodiments of the present disclosure.

The embodiments of the present disclosure further provide a computer-readable storage medium. The computer-readable storage medium is configured to store program code. The program code is configured for performing the recommendation message generation method for content recommendation according to the foregoing embodiments.

The embodiments of the present disclosure further provide a computer program product, and the computer program product includes a computer program. A processor of a computer device reads and executes the computer program to cause the computer device to perform the foregoing recommendation message generation method for content recommendation.

As disclosed, instead of directly inputting the to-be-recommended content description into a neural network model to generate the recommendation message, the seed attribute is first acquired from the to-be-recommended content description, information retrieval is performed in the information database according to the to-be-recommended content description and the seed attribute to retrieve the supplementary information corresponding to the to-be-recommended content description and the seed attribute, and then the prompt template is populated with the to-be-recommended content description and the supplementary information to generate the query message so that the query message is inputted into the first large-scale pre-trained language model to generate the recommendation message. In this case, the first large-scale pre-trained language model not only generates the recommendation message according to the to-be-recommended content description, but also considers the supplementary information retrieved according to the seed attribute. The supplementary information has a relatively large limiting effect when the first large-scale pre-trained language model generates the recommendation message, thereby improving the accuracy of generating the recommendation message. Thus, the generated recommendation message is easier to be clicked by or interacted with an object, thereby improving the recommendation conversion rate.

The terms “first”, “second”, “third”, “fourth”, and the like (if any) in the specification of the present disclosure and the foregoing accompanying drawings are used for distinguishing similar objects and are not necessarily used for describing a particular order or sequence. Data used in this way is exchangeable in a proper case so that the embodiments of the present disclosure described herein can be implemented in an order different from the order shown or described herein. Moreover, the terms “include”, “contain” and any other variants mean to cover the non-exclusive inclusion, for example, a process, method, system, product, or apparatus that includes a list of operations or units is not necessarily limited to those expressly listed operations or units, but may include other operations or units not expressly listed or inherent to such a process, method, product, or apparatus.

In the present disclosure, “at least one” means one or more, and “a plurality of” means two or more. The term “and/or” is used for describing an association relationship of associated objects and represents that three relationships may exist. For example, A and/or B may represent the following three cases: only A exists, both A and B exist, and only B exists, where A and B may be singular or plural. The character “/” generally represents an “or” relationship between the associated objects. “At least one of the following” or a similar expression refers to any combination of these items, including a single item or any combination of a plurality of items. For example, at least one of a, b, or c may represent: a, b, c, “a and b”, “a and c”, “b and c”, or “a and b and c”, where a, b, c may be singular or plural.

In the descriptions of the embodiments of the present disclosure, a plurality of (or multiple) means two or more, being greater than, being less than, exceeding a number, and the like are understood as excluding the number, and above, below, within a number, and the like are understood as including the number.

In the several embodiments provided in the present disclosure, the disclosed system, apparatus, and method may be implemented in other manners. For example, the apparatus embodiments described above are merely illustrative. For example, the partitioning of units is merely a logical function partitioning, and actual implementations may have additional partitioning, such as a plurality of units or assemblies may be combined or integrated into another system, or some features may be omitted or not performed. In addition, the couplings, direct couplings, or communication connections shown or discussed with respect to each other may be indirect couplings or communication connections through some interfaces, apparatuses, or units, and may be electrical, mechanical, or otherwise.

The units illustrated as separate components may or may not be physically separated, and the components shown as units may or may not be physical units, i.e., may be located in one place, or may alternatively be distributed over a plurality of network units. Some or all of the units may be selected to achieve the object of the solutions of the embodiments according to actual needs.

In addition, the functional units in various embodiments of the present disclosure may be integrated in one processing unit, or each unit may physically exist separately, or two or more units may be integrated in one single unit. The integrated unit may be implemented in the form of hardware, or may be implemented in the form of a software functional unit.

Integrated units, if implemented in software functional units and sold or used as stand-alone products, may be stored in a computer-readable storage medium. Based on such an understanding, the technical solution of the present disclosure essentially, the part contributing to the related art, or all or some of the technical solution may be embodied in the form of a software product. The computer software product is stored in a storage medium including several instructions for causing a computer apparatus (which may be a personal computer, a server, or a network apparatus, etc.) to perform all or part of the operations of the method according to various embodiments of the present disclosure. The foregoing storage medium includes: various media capable of storing program code, such as a USB flash drive, a mobile hard disk, a read-only memory (ROM), a random access memory (RAM), a magnetic disk, or an optical disc.

Various implementations provided in the embodiments of the present disclosure may be combined in different manners to form other embodiments, to achieve different technical effects.

The foregoing describes the implementations of the present disclosure in detail, but the present disclosure is not limited to the foregoing implementations. A person skilled in the art may further make various equivalent modifications or replacements without departing from the spirit of the present disclosure, and these equivalent modifications or replacements are all included within the scope defined by the claims of the present disclosure.

What is claimed is:

1. A method for generating a recommendation message for content recommendation, performed by an electronic device, the method comprising:
obtaining a recommendation request for content, the recommendation request containing a content description for recommendation;
predicting a seed attribute of the content based on the content description;
performing information retrieval in an information database based on the content description and the seed attribute to obtain supplementary information corresponding to the content description and the seed attribute;
populating a prompt template with the content description and the supplementary information to obtain a query message; and
generating, based on the query message, a recommendation message of the content for recommendation using a first large-scale pre-trained language model.

2. The method according to claim 1, wherein generating, based on the query message, the recommendation message of the content for recommendation using the first large-scale pre-trained language model comprises:
converting the query message into a first vector;
inputting the first vector into the first large-scale pre-trained language model and a first model that are connected in parallel, to obtain a second vector; and
converting the second vector into the recommendation message,
wherein the first vector and the second vector have a first dimension, and the first model comprises a first sub-model and a second sub-model that are connected in series; the first sub-model is configured to convert the first vector into a third vector, the third vector has a second dimension smaller than the first dimension, and the second sub-model is configured to convert the third vector into the second vector; and the first large-scale pre-trained language model and the first model are trained jointly, and only a weight matrix of the first model is adjusted during joint training.

3. The method according to claim 2, wherein the first large-scale pre-trained language model comprises a plurality of layers of first attention sub-models connected in series, and the first model comprises a plurality of layers of second attention sub-models connected in series; and
inputting the first vector into the first large-scale pre-trained language model and the first model that are connected in parallel, to obtain the second vector comprises:
inputting the first vector into a first attention sub-model of a first layer in the first large-scale pre-trained language model and a second attention sub-model of a first layer in the first model;
connecting a first output of a first attention sub-model of each layer and a second output of a second attention sub-model of the same layer in series, and inputting the connected first output and second output into a first attention sub-model of a next layer and a second attention sub-model of a next layer; and
connecting a first output of a first attention sub-model of a last layer in the first large-scale pre-trained language model and a second output of a second attention sub-model of a last layer in the first model in series to obtain the second vector.

4. The method according to claim 3, wherein the first attention sub-model has a first sub-channel weight matrix, a second sub-channel weight matrix, and a third sub-channel weight matrix, and the second attention sub-model in the same layer as the first attention sub-model has a fourth sub-channel weight matrix, a fifth sub-channel weight matrix, and a sixth sub-channel weight matrix; and
the first output is generated by the first attention sub-model by performing:
transforming an input vector of the first attention sub-model based on the first sub-channel weight matrix and the fourth sub-channel weight matrix to obtain a first channel vector;
transforming the input vector of the first attention sub-model based on the second sub-channel weight matrix and the fifth sub-channel weight matrix to obtain a second channel vector;
transforming the input vector of the first attention sub-model based on the third sub-channel weight matrix and the sixth sub-channel weight matrix to obtain a third channel vector;
determining a mutual influence matrix of elements in the input vector based on the first channel vector and the second channel vector; and
determining the first output based on the mutual influence matrix and the third channel vector.

5. The method according to claim 4, wherein transforming the input vector of the first attention sub-model based on the first sub-channel weight matrix and the fourth sub-channel weight matrix to obtain the first channel vector comprises: performing a weighted sum operation on a first product vector of the input vector and the first sub-channel weight matrix and a second product vector of the input vector and the fourth sub-channel weight matrix to obtain the first channel vector; and
transforming the input vector of the first attention sub-model based on the second sub-channel weight matrix and the fifth sub-channel weight matrix to obtain the second channel vector comprises: performing a weighted sum operation on a third product vector of the input vector and the second sub-channel weight matrix and a fourth product vector of the input vector and the fifth sub-channel weight matrix to obtain the second channel vector; and
transforming the input vector of the first attention sub-model based on the third sub-channel weight matrix and the sixth sub-channel weight matrix to obtain the third channel vector comprises: performing a weighted sum operation on a fifth product vector of the input vector and the third sub-channel weight matrix and a sixth product vector of the input vector and the sixth sub-channel weight matrix to obtain the third channel vector.

6. The method according to claim 1, wherein the seed attribute comprises a content subject for recommendation and a content type for recommendation; and
predicting the seed attribute of the content based on the content description comprises:
inputting the content description into a subject prediction model to obtain a predicted content subject; and
inputting the content description into a type prediction model to obtain a predicted content type.

7. The method according to claim 1, wherein the information database comprises a plurality of supplementary information units; and
performing the information retrieval in the information database based on the content description and the seed attribute to obtain the supplementary information corresponding to the content description and the seed attribute comprises:
using the seed attribute as a keyword, and screening supplementary information units containing keywords from the plurality of supplementary information units as screened supplementary information units; and
acquiring, from the screened supplementary information units, screened supplementary information units matching the to-be-recommended content description, and integrating the screened supplementary information units into the supplementary information corresponding to the to-be-recommended content description and the seed attribute.

8. The method according to claim 7, wherein acquiring, from the screened supplementary information units, the screened supplementary information units matching the content description comprises:
generating a first semantic vector based on the content description;
generating second semantic vectors based on the screened supplementary information units;
determining similarities between the first semantic vector and the second semantic vectors corresponding to the screened supplementary information units; and
determining, based on the similarities, the screened supplementary information units matching the to-be-recommended content description.

9. The method according to claim 7, where the information database is generated by performing:
acquiring a recommendation message browsing record of a content recommendation platform object;
acquiring seed words based on the recommendation message browsing record;
performing corpus retrieval using the seed words to obtain candidate segments containing the seed words; and
generating the supplementary information units based on the candidate segments to form the information database.

10. The method according to claim 9, wherein acquiring the seed words based on the recommendation message browsing record comprises:
acquiring, based on the recommendation message browsing record, a quantity of opening times that a link corresponding to each historical recommendation message is opened by the content recommendation platform object;
determining a seed recommendation message in the historical recommendation message based on the quantity of opening times; and
performing keyword extraction on the seed recommendation message to obtain the seed word.

11. The method according to claim 9, wherein the supplementary information unit is a key-value pair set; and
generating the supplementary information units based on the candidate segments comprises:
performing semantic recognition on the candidate segment to obtain a semantic recognition result; and
acquiring, based on the semantic recognition result, a plurality of key-value pairs from the candidate segment to form the key-value pair set.

12. The method according to claim 1, wherein generating, based on the query message, the recommendation message of the content using the first large-scale pre-trained language model comprises:
generating, based on the query message, a fourth vector using the first large-scale pre-trained language model;
determining an object group for processing to which a target object belongs;
acquiring a fifth vector based on a group label of the object group; and
inputting the fifth vector and the fourth vector that are connected in series into a second large-scale pre-trained language model to obtain the recommendation message to be delivered to the target object.

13. The method according to claim 12, wherein inputting the fifth vector and the fourth vector that are connected in series into the second large-scale pre-trained language model to obtain the recommendation message to be delivered to the target object comprises: inputting the fifth vector and the fourth vector that are connected in series into the second large-scale pre-trained language model and a second model that are connected in parallel, to obtain a sixth vector, and converting the sixth vector into the recommendation message to be delivered to the target object,
wherein the fifth vector and the fourth vector that are connected in series have a third dimension, and the sixth vector further has the third dimension; the second model comprises a third sub-model and a fourth sub-model that are connected in series; the third sub-model is configured to convert the fifth vector and the fourth vector that are connected in series into a seventh vector, the seventh vector has a fourth dimension smaller than the third dimension, and the fourth sub-model is configured to convert the seventh vector into the sixth vector; and the second large-scale pre-trained language model and the second model are trained jointly, and only a weight matrix of the second model is adjusted during joint training.

14. The method according to claim 12, wherein determining the object group for processing to which the target object belongs comprises:
acquiring an object label of the target object;
acquiring group labels of a plurality of first candidate object groups;
acquiring matching degrees between the object label and the group labels of the plurality of first candidate object groups; and
selecting, based on the matching degrees, the object group to which the target object belongs from the plurality of first candidate object groups.

15. The method according to claim 12, wherein determining the object group for processing to which a target object belongs comprises:
acquiring object attributes of a plurality of content recommendation platform objects, the plurality of content recommendation platform objects comprising the target object;
clustering the plurality of content recommendation platform objects based on the object attributes of the plurality of content recommendation platform objects to obtain a plurality of second candidate object groups; and
determining the object group to which the target object belongs among the plurality of second candidate object groups; and
acquiring the fifth vector based on the group label of the object group comprises:
acquiring the group label based on the object attributes of the content recommendation platform objects in the object group; and
converting the group label into the fifth vector.

16. The method according to claim 15, wherein acquiring the group label based on the object attributes of the content recommendation platform objects in the object group comprises:
determining a quantity of occurrence times of each object attribute in the plurality of content recommendation platform objects of the object group; and
determining the group label based on the quantity of occurrence times.

17. An electronic device, comprising one or more processors and a memory containing a computer program that, when being executed, causes the one or more processors to perform:
obtaining a recommendation request for content, the recommendation request containing a content description for recommendation;
predicting a seed attribute of the content based on the content description;
performing information retrieval in an information database based on the content description and the seed attribute to obtain supplementary information corresponding to the content description and the seed attribute;
populating a prompt template with the content description and the supplementary information to obtain a query message; and
generating, based on the query message, a recommendation message of the content for recommendation using a first large-scale pre-trained language model.

18. The device according to claim 17, wherein the one or more processors are configured to perform:
converting the query message into a first vector;
inputting the first vector into the first large-scale pre-trained language model and a first model that are connected in parallel, to obtain a second vector; and
converting the second vector into the recommendation message,
wherein the first vector and the second vector have a first dimension, and the first model comprises a first sub-model and a second sub-model that are connected in series; the first sub-model is configured to convert the first vector into a third vector, the third vector has a second dimension smaller than the first dimension, and the second sub-model is configured to convert the third vector into the second vector; and the first large-scale pre-trained language model and the first model are trained jointly, and only a weight matrix of the first model is adjusted during joint training.

19. The device according to claim 18, wherein the first large-scale pre-trained language model comprises a plurality of layers of first attention sub-models connected in series, and the first model comprises a plurality of layers of second attention sub-models connected in series; and
the one or more processors are configured to perform:
inputting the first vector into a first attention sub-model of a first layer in the first large-scale pre-trained language model and a second attention sub-model of a first layer in the first model;
connecting a first output of a first attention sub-model of each layer and a second output of a second attention sub-model of the same layer in series, and inputting the connected first output and second output into a first attention sub-model of a next layer and a second attention sub-model of a next layer; and
connecting a first output of a first attention sub-model of a last layer in the first large-scale pre-trained language model and a second output of a second attention sub-model of a last layer in the first model in series to obtain the second vector.

20. A non-transitory computer-readable storage medium containing a computer program that, when being executed, causes the at least one processor to perform:
obtaining a recommendation request for content, the recommendation request containing a content description for recommendation;
predicting a seed attribute of the content based on the content description;
performing information retrieval in an information database based on the content description and the seed attribute to obtain supplementary information corresponding to the content description and the seed attribute;
populating a prompt template with the content description and the supplementary information to obtain a query message; and
generating, based on the query message, a recommendation message of the content for recommendation using a first large-scale pre-trained language model.
